(19) United States
(12) Patent Application Publication
(10) Pub. No.: US 2011/0055746 A1
(43) Pub. Date: Mar. 3, 2011

(54) SCUBA DIVING DEVICE PROVIDING UNDERWATER NAVIGATION AND COMMUNICATION CAPABILITY

(75) Inventors: Alberto Mantovani, Laguna Niguel, CA (US); Craig Oberlin, Tustin, CA (US)

(73) Assignee: DIVENAV, INC, TUSTIN, CA (US)

(21) Appl. No.: 12/600,239

(22) PCT Filed: May 8, 2008
(86) PCT No.: PCT/US08/63108

§ 371 Date: Oct. 29, 2010

Related U.S. Application Data
(60) Provisional application No. 60/930,173, filed on May 15, 2007.
(60) Provisional application No. 60/930,174, filed on May 15, 2007.

(51) Int. Cl. G06F 3/048

(52) U.S. Cl. 715/771; 715/848

(57) ABSTRACT

Devices and systems are provided which may be used to navigate and communicate while diving in dive sites and improve the safety of the diving experience. For example, in certain embodiments, a diver area system is provided which utilizes virtual underwater information to provide the user with their location, the location of other divers (or “buddies”), and/or location of a surface object (e.g., a dive boat). In certain embodiments, the devices and systems disclosed herein may provide user with their location relative to one or more buddies. The user can thus navigate intelligently throughout the dive site and track the location of their buddies which can improve dive safety and/or efficiency. Additionally, the user can communicate with one or more buddy divers and/or surface-based objects and individuals using embodiments of the disclosure.

### CROSS-REFERENCE TO RELATED APPLICATIONS

The present application claims priority benefit of U.S. Provisional Application No. 60/930,173, filed May 15, 2007, and U.S. Provisional Application No. 60/930,174, filed May 15, 2007, which are incorporated in their entirety by reference herein.

### BACKGROUND

1. Field

The present disclosure relates to devices, systems and methods for underwater dive navigation, communication, training, and safety.

2. Description of the Related Art

Particularly since the introduction of the Self-Contained Underwater Breathing Apparatus (SCUBA) in the 1940's, people are exploring underwater environments in great numbers. According to some accounts, the number of SCUBA divers alone has surpassed 10 million and is quickly approaching 20 million.

The increase in the number of those exploring underwater areas has triggered significant progress in diving-related technology. However, there are still areas, such as safety, in which significant needs still exist. For example, there are significant inherent risks associated with diving. Conditions such as decompression sickness, inner ear barotraumas, pulmonary barotraumas, and arterial gas embolism can occur under certain circumstances and can lead to serious injury.

Divers can reduce risks and improve their experience by following certain practices such as keeping track of their location and diving with other divers (or “buddies”). One way divers gauge their position is by using a compass to keep track of their directional heading and by keeping track of a number of kick strokes they have made or amount of time they have been swimming to keep track of their relative distance from a point of reference. However, these practices can be difficult to implement in a highly dynamic diving environment. Even when followed rigorously, such techniques can be imprecise. Environmental factors such as visibility increase the chances of disorientation and separation from buddies.

Divers can also reduce risks and increase the enjoyment of the diving experience by undergoing effective training and preparing properly. For example, divers are often required to go through an initial training and certification process. Divers may also, for example, watch dive videos, consult dive maps or other divers before diving in order to prepare for and/or familiarize themselves with a dive, particularly if it is their first experience diving at a given site. However, these solutions are limited. For example, divers are generally not able to interact with the underwater environment. Moreover, existing training techniques usually involve hiring a guide or instructor which can be expensive and burdensome.

### SUMMARY

In certain embodiments, devices and systems are provided which may be used to navigate and communicate while diving in dive sites and improve the safety of the diving experience. For example, in certain embodiments, a diver area system is provided which utilizes virtual underwater information to provide the user with their actual or relative location, the actual or relative location of other divers (or “buddies”), and/or the actual or relative location of a surface object (e.g., a dive boat). In certain embodiments, the devices and systems disclosed herein may provide user with their location relative to one or more buddies. In certain embodiments, the user can thus navigate intelligently throughout the dive site and track the location of their buddies, which can improve, for example, dive safety and/or efficiency. Additionally, the user can communicate with one or more buddy divers and/or surface-based objects and individuals using embodiments of the disclosure.

In accordance with the present disclosure, a virtual underwater environment is provided. In certain embodiments, for example, users are able to simulate interacting with actual underwater regions using the virtual underwater environment. For example, in certain embodiments, users are able to simulate diving, such as scuba diving, in under water regions using the virtual underwater environment. The underwater regions are also referred to as “dive sites” throughout the disclosure. One benefit of certain embodiments of the virtual underwater environment is that it allows users to familiarize themselves with actual dive sites using the virtual environment, which can, for example, improve the user's diving safety and/or efficiency when they dive in the actual dive site. For example, embodiments described herein can reduce the chances that a user will become lost or panic when they actually dive at the dive site. Certain embodiments described herein may allow instructors to more effectively train divers.

In certain embodiments, a diver area system is disclosed for providing a representation of a position of a SCUBA diver. The diver area system comprises a first housing configured to be worn by a SCUBA diver while diving and adapted to house system components. The diver area system also comprises a processor housed by the first housing and a storage element housed by the first housing and operably coupled to the processor. The storage element is configured to store map data corresponding to a representation of a dive site. The diver area system also includes a motion tracking module housed by the first housing and operably coupled to the processor. The motion tracking module generates motion data indicative of the motion of the diver within the dive site, wherein the processor is configured to correlate the motion data with the map data and to generate display data corresponding to a graphical representation of the current position of the SCUBA diver within the dive site. The diver area system also includes a display configured to receive the display data and to generate a visible image representing the current position of the SCUBA diver within the dive site. In some embodiments, the system further includes a communication module housed by the first housing and operably coupled to the processor, wherein the communication module is configured to send signals representing at least in part a position of the SCUBA diver within the dive site. The system of certain embodiments also comprises a communication module housed by the first housing and operably coupled to the processor wherein the communication module is configured to receive signals representing at least in part a position of a second SCUBA diver within the dive site. In some embodiments, the display is configured to generate a visible image representing the current position of the second SCUBA diver within the dive site. In some embodiments, the received signals representing at least in part a position of the second SCUBA diver include position information calculated by correlating motion of the second SCUBA diver within the dive site with the map data. In certain embodiments, the signals are sent using a wireless protocol. The signals are received wirelessly in the form of one or more data packets in certain embodiments. In some embodiments, the diver area system further includes a communication module housed by the first housing and operably coupled to the processor, the communication module configured to receive surface position signals representing a position of one or more surface-based objects, wherein the processor is configured to process the surface position signals to generate second display data representing the current position of the one or more surface-based objects, and wherein the display uses the second display data to generate a visible image representing the current position of the one or more surface-based objects. In certain embodiments, a second housing houses the display. The diver area system of some embodiments also includes a first communication module housed by the first housing and a second communication module housed by the second housing, wherein the second communication module receives the display data from the first communication module. In certain embodiments, the first and second communication modules are in wireless communication with one another. The motion tracking module comprises an intertial measurement unit in various embodiments. In certain embodiments, the display data corresponds to a representation of a bird's eye view of the dive site. The display data corresponds to a three-dimensional graphical representation of the dive site in some embodiments. The diver area system of certain embodiments also includes a communication module housed by the first housing and operably coupled to the processor. The communication module is configured to receive first sensor signals from a first sensor wherein the first sensor measuring a first value that can change during a SCUBA diving session. The processor is configured to receive data representative of the first sensor signals to generate first sensor display data indicative of the first value. The display uses the first sensor display data to generate a visible image representing the first value. In certain embodiments, the communication module uses a wireless communication protocol to receive the first sensor signals from the first sensor. The communication module of some embodiments receives second sensor signals from a second sensor, the second sensor measuring a second value that can change during a SCUBA diving session, wherein the processor is configured to receive data representative of the second sensor signals to generate second sensor display data indicative of the second value, and wherein the display uses the second sensor display data to generate a visible image representing the second value. In various embodiments, the first sensor measures a physiological parameter associated with the SCUBA diver, and air pressure in an air tank being used by the SCUBA diver. The second sensor of some embodiments measures a physiological parameter associated with a second SCUBA diver. The second sensor measures air pressure in an air tank being used by the SCUBA diver in some embodiments.

In certain embodiments, a method of providing a graphical representation of position to a SCUBA diver in a dive site on a portable underwater device is provided. The method comprises: 1) receiving map data corresponding to a representation of the dive site; 2) generating motion data indicative of the motion of a SCUBA diver; 3) correlating the motion data with the map data; 4) generating display data which represent a position of the SCUBA diver within the dive site; and 5) displaying a visible image on the portable underwater device that graphically represents the position of the SCUBA diver. In certain embodiments, the method also involves 1) receiving position data representing the position of a second SCUBA diver; 2) generating second display data which represent a position of the second SCUBA diver within the dive site; and 3) displaying a visible image on the portable underwater device that graphically represents the position of the second SCUBA diver. In certain embodiments, the method can further comprise: 1) receiving position data representing the position of a surface-based object; 2) generating second display data which represent a position of the surface-based object; and 3) displaying a visible image on the portable underwater device that graphically represents the position of the surface-based object.

In some embodiments, a method of providing dive site information is provided. The method comprises: 1) storing map data that represent geographical characteristics of a dive site; and 2) providing the map data to a device configured to correlate the map data with position data representing a position of a SCUBA diver within the dive site and configured to display a visible image representing the position of the SCUBA diver within the dive site. IN certain embodiments, the visible image comprises a representation of a bird's eye view of the dive site. The visible image comprises a three-dimensional representation of the dive site in some embodiments.

In certain embodiments, a computer implemented method of providing a virtual training environment for SCUBA diving is provided. The method includes: 1) receiving dive site data at least partially corresponding to at least one actual underwater region wherein the dive site data comprises terrain data comprising information relating to the bathymetry of the at least one underwater region. The dive site data further comprises scene data comprising information corresponding to one or more objects within the at least one underwater region; 2) processing the dive site data to generate an interactive graphical simulation including a graphical representation of the at least one actual underwater region; 3) providing a simulation interface for interacting with the graphical simulation, the simulation interface including at least one movement command; and 4) responding to the at least one movement command by generating a modified graphical representation of the at least one actual underwater region to simulate movement within the underwater region in a direction corresponding to the movement command. In certain embodiments, the simulation interface includes a buoyancy adjustment control. In some embodiments, the method further includes: 1) responding to at least one signal generated by activating the buoyancy adjustment control by generating a modified graphical representation of the at least one actual underwater region to simulate a change in depth within the underwater region; and 2) displaying a depth indicator representing a depth within the at least one underwater region. In certain embodiments, the method further comprises: 1) receiving SCUBA diver configuration data including a representation of air pressure in an air tank; 2) displaying an air pressure indicator representing air pressure in the air tank; and 3) periodically modifying the displayed air pressure indicator to represent a decreased air pressure in the air tank, wherein the rate of decrease in air pressure that is represented by the air pressure indicator varying with changes in depth represented by the depth indicator. In certain embodiments, the method further comprises: 1) associating one or more annotation items with a feature of the graphical simulation; and 2) providing the one or more annotation items to a user. The feature can comprise an object, event, or location associated with the underwater region in various embodiments. The annotation item of various embodiments can comprise video, text, or advertising information in various embodiments. In certain embodiments the method further comprises displaying advertising content to a user based on one or more behaviors or characteristics of the user. In some embodiments, the method further includes displaying advertising content to a user based on one or more characteristics of the at least one underwater region. In certain embodiments, the further comprises: 1) estimating the partial pressure of inert gases in a SCUBA diver's tissues; and 2) displaying a decompression indicator representing that direct ascent without one or more decompression stops would be unsafe. In some embodiments, the method further includes: 1) recording information representing at least a portion of a simulated SCUBA dive in the at least one underwater region; and 2) responding to a replay command to generate images representing a replay of at least a portion of the simulated SCUBA dive. In some embodiments, the method further comprises: 1) assessing a quality of a simulated SCUBA dive in the at least one underwater region; and 2) providing feedback representing the assessed quality of the simulated SCUBA dive. The feedback is provided during the simulated SCUBA dive in some embodiments. The feedback includes an assessment of the level of safety used in ascending during the simulated SCUBA dive in some embodiments. In certain embodiments, the method further comprises estimating depth safety based at least upon an air pressure value and an estimated decompression need, wherein the feedback comprises an assessment of depth safety. In some embodiments, the graphical simulation includes a three-dimensional graphical simulation and the dive site data further comprises three-dimensional modeling data. The terrain data further comprises topography data related to the topography of the at least one underwater region in some embodiments. In certain embodiments, the dive site data further comprises marine life data.

In certain embodiments, a system configured to train divers and familiarize them with actual dive sites is provided. The system comprises input data comprising diver configuration parameters, environment configuration parameters, and dive site data, the dive site data at least partially corresponding to an actual underwater region. In certain embodiments, the system further includes a simulator logic engine configured to accept the input data and to generate an interactive graphically simulated underwater region based on the input data, the interactive graphical simulation configured to simulate actual dive conditions. The system of some embodiments also includes a 3D engine in communication with the simulator logic engine, the 3D engine rendering a three-dimensional representation of the dive site based on the dive site data. In certain embodiments, the system comprises a user interface module in communication with the simulator logic engine and the 3D engine and comprising a dive simulation interface configured to allow a user to explore the graphically simulated underwater region. In certain embodiments, the system comprises one or more annotation items associated with a feature of the dive site, the one or more annotation items available to a user through the user interface module. In some embodiments, the feature comprises an object, location, or event associated with the dive site. In some embodiments, the annotation item comprises video, text, and/or advertising content. The system of certain embodiments further includes advertising content provided to the user based on one or more behaviors or characteristics of the user and provided through the user interface module. In some embodiments the system also includes advertising content provided to the user based on one or more characteristics of the at least one underwater region and provided through the user interface module. The actual dive conditions can comprise at least one physiological condition or at least one item of selected SCUBA diving equipment. The simulator logic engine of some embodiments records at least a portion of a simulated SCUBA dive in the simulated underwater region and permits the user to replay the recorded portion of the simulated SCUBA dive. In certain embodiments, the simulator logic engine assesses SCUBA diver performance in at least one aspect of SCUBA diving during a simulated SCUBA dive in the simulated underwater region and provides feedback indicative of the assessed performance.

In certain embodiments, the dive site data further comprises marine life data and the graphically simulated underwater region includes graphically simulated marine life. The dive site data of some embodiments further comprises weather data and the graphically simulated underwater region includes graphically simulated weather conditions. The dive site data can further comprises water effects data and the graphically simulated underwater region includes graphically simulated water effects. In certain embodiments, a computer readable medium is disclosed having stored thereon a computer program which embodies the system.

In some embodiments, an underwater communications system is provided. The system of certain embodiments includes a plurality of diver area networks. Each of the diver area networks comprise a diver area system removably attached to a SCUBA diver and a plurality of components in wireless underwater communication with each other during a SCUBA dive. The system further includes one or more buddy area networks. The buddy area networks each comprise at least two diver area systems in wireless underwater communication with each other during a SCUBA dive. In certain embodiments, the underwater communications system further includes one or more site area networks comprising a diver area system in communication with at least one surface based object during a SCUBA dive. The communication frequencies used by the plurality of diver area networks, the one or more buddy area networks, and the one or more site area networks do not substantially interfere with each other in certain embodiments.

In certain embodiments, a method of allowing a user to select a dive site for virtual exploration is provided. The method includes: 1) providing an initial view substantially representing the Earth; 2) receiving an input indicating a desired region within the initial view; 3) providing a first magnified view representing a magnified above-water view of the desired region; and 4) providing a magnified view representing a below-water view of a dive site within the desired region. In certain embodiments, the transition between the initial view, the first magnified view, and the second view is substantially visually continuous. The second magnified view is a three-dimensional representation of the dive site in some embodiments.

In certain embodiments, a system is provided comprising a storage server coupled to a network and including a three-dimensional map of one or more diving locations. In certain embodiments, the system also includes an application server coupled to the network that runs an application server program that allows a user to access the three-dimensional map of one or more diving locations. The system of some embodiments further includes a client computer coupled to the network and including a simulator application configured to access the remote application server and to generate a three-dimensional graphical simulation of the one or more diving locations based on the three-dimensional map and to provide an interface allowing a user to view and explore the one or more diving locations with the three-dimensional graphical simulation. In certain embodiments, the three-dimensional digital map is encrypted and access to the encrypted three-dimensional digital map is granted based on air credits which the user can purchase, earn, exchange and consume. In some embodiments the client computer is a portable underwater computer carried by a SCUBA diver. In some embodiments, the client computer transmits second map data to a portable computer which is configured for underwater use and which is configured to generate a visible representation of the one or more dive locations.

In certain embodiments, a navigation system for a SCUBA diver is provided. The navigation system of some embodiments includes a device including an application program configured to store a map of one or more diving locations, the device comprising. In certain embodiments, a navigation unit attachable to the SCUBA diver is included. The navigation unit can include an inertial measurement unit configured to measure the motion of the diver, wherein the navigation unit is configured to determine a position of the SCUBA diver by correlating the output of the inertial measurement unit with the map of the one or more dive locations. The navigation system of certain embodiments also includes a console unit attachable to the SCUBA diver and which includes a display. The console unit communicates wirelessly with the navigation unit in certain embodiments. In various embodiments, the inertial measurement unit is configured to be initialized by a user and/or be configured to be GPS assisted.

### BRIEF DESCRIPTION OF THE DRAWINGS

FIG. 1 illustrates a high-level diagram of an example underwater environment navigation and communication system topology incorporating one or more diver area systems in accordance with certain embodiments described herein.

FIG. 2 illustrates a high-level diagram an example topology in which a diver area system may be implemented in accordance with certain embodiments described herein.

FIG. 3 is a high-level diagram of an example diver-area system in accordance with certain embodiments described herein.

FIG. 4 is a chart showing operating characteristics of example diver-area, buddy-area, and site-area networks of an example underwater environment navigation and communication system in accordance with certain embodiments described herein.

FIG. 5 illustrates a high-level diagram of an example network topology on which a virtual underwater environment can be implemented in accordance with certain embodiments described herein.

FIG. 6 illustrates a high-level diagram of an example computing system on which components of a virtual underwater environment may be implemented in accordance with certain embodiments described herein.

FIG. 7 illustrates a high-level diagram of an example virtual underwater environment database in accordance with certain embodiments described herein.

FIG. 8 illustrates a high-level diagram of an example virtual underwater environment simulator application in accordance with certain embodiments described herein.

FIG. 9 illustrates a high-level diagram of an example virtual underwater environment dive site in accordance with certain embodiments described herein.

FIG. 10 sequentially illustrate an example virtual underwater environment dive site selection interface in accordance with certain embodiments described herein.

FIG. 11 illustrates an example screen display of a virtual underwater environment dive simulation interface in accordance with certain embodiments described herein.

FIG. 12 shows an example method of configuring a virtual underwater environment simulation application in accordance with certain embodiments described herein.

FIG. 13 shows an example method of providing a virtual underwater environment simulation environment in accordance with certain embodiments described herein.

### DETAILED DESCRIPTION

Systems and methods which represent various embodiments and example applications of the present disclosure will now be described with reference to the drawings. For purposes of illustration, some embodiments will be described in the context of a virtual underwater environment implemented on a computer or on multiple computers. However, the present invention is not limited by the type of environment in which the systems and methods are used; the systems and methods may be used in other environments, such as, for example, cell phones, other mobile devices and so forth. Moreover, the specific implementations described herein are set forth in order to illustrate, and not to limit, the invention.

### I. Overview of Embodiments of an Underwater Navigation and Communication System

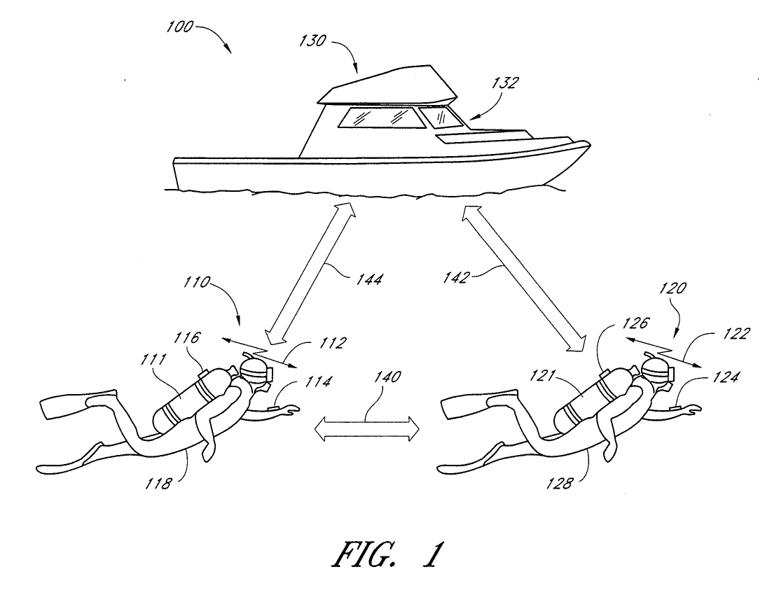

FIG. 1 illustrates a high-level diagram of an example underwater environment navigation and communication system 100 topology incorporating one or more diver area systems 110, 120, in accordance with certain embodiments described herein. A first diver area system 110 including a backpack unit 116 and a console unit 114 is associated with a first diver 118. The backpack unit 116 is in communication with the console unit 114 and/or one or more pieces of the diver's equipment 111 (e.g., air pressure, depth, chronograph and/or other gauges) over the link 112. In certain embodiments, the backpack unit 116 performs a substantial amount of the processing of the diver area system 110 and the console unit 114 provides a substantial amount of the user interface functionality of the diver area system 110. The network topology allowing the communication between the backpack unit 1120, the console unit 1110, and/or the diver's equipment is referred to as a diver area network (“DAN”).

In certain embodiments, the communication system 120 allows the first diver 110 to communicate with a second diver 128 over a buddy-area network via the link 140. For example, the buddy area network (“BAN”) includes another diver area system 120 associated with the second buddy 128. In certain embodiments, the other diver area system 120 includes a backpack unit 126 in communication with a console unit 124 and or one or more pieces of the buddy's equipment 121 over a link 122. In certain embodiments, the BAN allows the buddies 118, 128 to track their relative positions with respect to each other. For example, a graphical representation of the buddy diver can be provided to the user in certain embodiments on the console unit 124. In certain embodiments, a graphical representation showing the position of the user and buddy diver(s) can be provided. In certain embodiments, the BAN allows the buddies 118, 128 to communicate with one another. For example, the buddies 118, 128 may communicate in writing using the keyboards on the console units 114, 124 or by voice using the microphones and/or speakers of the console units 114, 124.

One or both of the first diver 118 and the second diver 128, and in come embodiments, additional divers, communicate over a site area network (“SAN”) over the links 142, 144 with one or more surface-based objects 130 (e.g., a boat) including one or more computing systems 132 associated with the surface-based object 130. For example, the boat 130 may, in certain preferred embodiments, include another diver area system, a computing system including capabilities similar to a diver area system, or a client system as described herein. In certain embodiments, the SAN allows for communications between divers 118, 128 within the SAN. In certain other embodiments, the surface-based object 130 may include some other computing system capable of communicating with one or more of the diver area systems 110, 120. In certain embodiments, the surface-based object 130 is not a boat, but may be a building located on shore, a surface-based individual, a buoy, or some other object. The term surface-based object is used for illustration purposes and is not intended to be limiting. In certain embodiments, for example, the surface-based object 130 may not actually be located on the surface, but may be another object located underwater such as a submarine, or an object located above the surface, such as a helicopter or airplane. For example, in certain embodiments, the SAN may be used in a rescue mission in which a helicopter can communicate with and/or find and track divers over the SAN.

The DAN, BAN, and SAN of certain embodiments can serve to improve the safety, efficiency, and enjoyment of the diving experience. For example, SAN can help surface-based individuals communicate with and track the movements of the divers in order to ensure the safety of the divers and/or help provide the divers with an enjoyable experience. For example, in one embodiment, a dive instructor or guide may monitor the dive path of a group of divers and provide instruction and advice to the divers over the SAN from the surface as they move throughout the dive site. In certain embodiments, the instructor may be diving with the student divers and may perform the monitoring and tracking over the BAN. The BAN and SAN may also reduce incidents of buddy separation, reduce the use of inefficient communication means between divers (e.g., hand signals) which can be difficult to implement, particularly in cloudy conditions. Moreover, divers enjoy greater peace of mind knowing where their buddies are located even when they may not be able to see them and where they are in relation to their dive boat.

In certain embodiments, the DAN, BAN, and SANs are implemented using various communication methods and protocols described herein. In certain embodiments, the communication is acoustic based. In various embodiments, the communication system combines multiple communication and networking technologies that facilitate communication both underwater and at the surface.

As described herein, some of the various communication links described herein may be acoustic based communication links. As will be appreciated by those of ordinary skill from the disclosure provided herein, various technologies may be incorporated to implement the communication links. For example, in certain embodiments acoustic modems such as frequency shift keying (FSK) and/or phase-shift keying (PSK) modems may be used for underwater communication. Quadrature amplitude modulation (QAM) can be used to encode information and increase bandwidth. Channel equalizers such as decision-feedback equalizers (DFEs) can be implemented to learn the channel response. In various other embodiments, other communication methods, such as, for example, optical wave communication may be used.

In one embodiment, a diver area system, such as one of the diver area systems described herein, may be configured generally as a networked gateway. For example, each component (e.g., the backpack unit, the console unit, diver equipment, other diver area systems, etc.) within the communication system can have a unique address, such as an IEEE medium access control (MAC) address. The DAN, BAN, and SAN can include three non interfering networks. The DAN of certain embodiments is generally used for relatively short range communication, the BAN is used for exchanging data with one or more buddies, and the SAN is used for wider area connectivity, such as with a surface-based vessel during an emergency situation.

As will be appreciated by those of ordinary skill from the disclosure herein, the networks and associated links described herein can implement various methodologies. For example, communication channel sharing methodologies may be used to control access to the various communication links or channels. Techniques such as frequency, time, and code-division multiple-access (FDMA, TDMA, and CDMA) may be employed. In certain embodiments, multiple access methods such as carrier sense multiple access (CSMA) may be employed. Collision avoidance mechanisms such as CSMA with collision avoidance (CSMA/CA) can be employed in various embodiments.

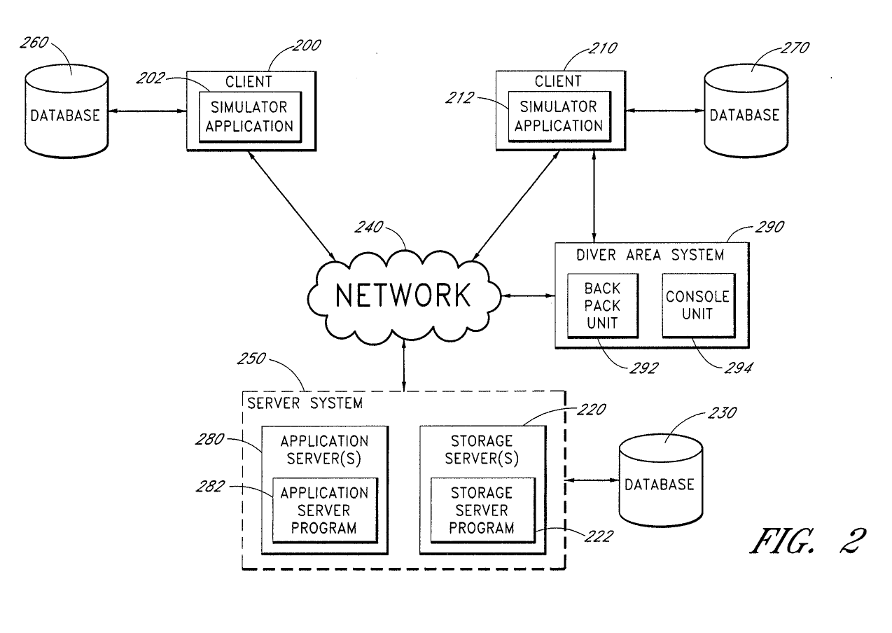

FIG. 2 illustrates a high-level diagram an example topology in which a diver area system 290 may be implemented in accordance with certain embodiments described herein. In certain embodiments, the diver area system 290 may allow users to navigate and communicate while diving in actual dive sites and/or improve the safety of the diving experience. For example, in certain embodiments, the diver area system 290 may provide the user with their actual or relative location, the actual or relative location of other divers (or “buddies”), and/or the actual or relative location of a surface object (e.g., a dive boat). In certain embodiments, the diver area system 290 may provide a location relative to one or more buddies. In certain embodiments, the user can thus navigate intelligently throughout the actual dive site and/or track the location of their buddies, which can improve, for example, dive safety and/or efficiency. Additionally, the user can communicate with one or more buddy divers and/or surface-based objects and individuals using the diver area system 290.

In one embodiment, one or more client systems 200, 210 communicate via a network 240 with a server system 250 which communicates with an underwater environment database 230. There may be any number of client 200, 210 and server 250 systems. In the illustrated embodiment, the client 200, 210 and server 250 systems are computer systems. In other embodiments, the client 200, 210 and server 250 systems may be other types of devices, such as, for example, mobile devices. In some embodiments, the client 200, 210 and server 250 systems may be any combination of different types of devices. For example, in one embodiment, some of the client systems 200, 210 may be computer systems, some may be mobile devices, and the server system 250 system may be a computer system. The client computer may, in certain embodiments, be a user's personal computer.

In some embodiments, the server system 250 maintains the database 230 which includes some or all of the data which defines a virtual underwater environment. As described herein, the virtual underwater environment includes dive site information such as dive site map and terrain information. In certain embodiments, the server system 250 includes a storage server 220 and an application server 280. In certain other embodiments, the functions of the storage 220 and application 280 servers of server system 250 are included in one server. In certain embodiments, for example, the client systems, 200, 210 also include a database 260, 270 which may comprise some or all of the data which defines the virtual underwater environment. In certain embodiments, for example, portions of the environment are included on the client databases 260, 270 and portions of the environment are included on the server database 230. The illustrated example is just one embodiment of a topology in which a diver area system 290 can be implemented. In some embodiments, for example, the server system 250 and database 230 may not be included in the network topology and client systems 200, 210 can provide the virtual underwater environment to a user without the server system 250 or the database 230.

In certain embodiments the diver area system 290 includes a portable computing system or mobile device. The diver area system 290 is co-located with a diver when diving in a dive site. In certain embodiments, the diver area system 290 communicates over the network 240 with the client system 200 and/or a server system 250. As described herein, the diver area system 290 may be used to navigate while diving in an actual dive site and/or improve the safety of the diving experience.

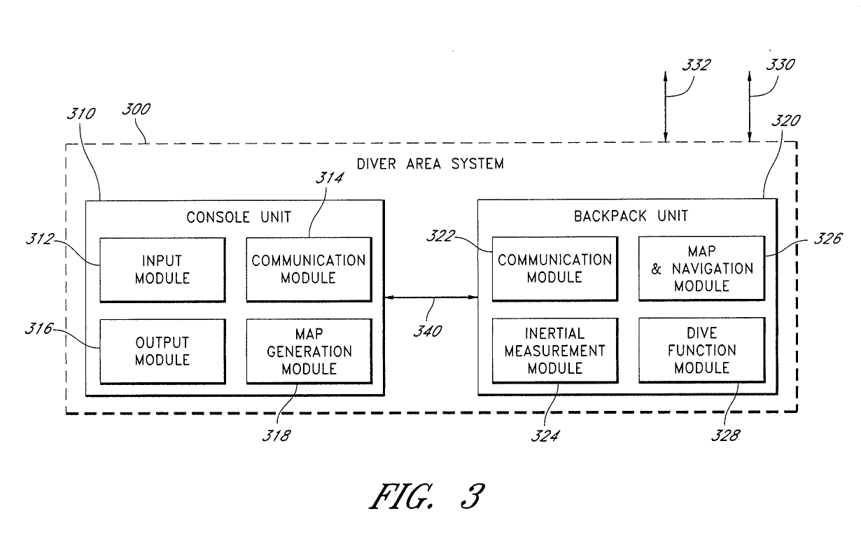

The diver area system 290 can be used in conjunction with other components, such as, for example, another diver area system 290, a client system 200, 210, server system 250, and/or diver equipment to allow the user to navigate while diving and/or improve the safety of the diving experience. In certain embodiments, for example, a client system 200 or another diver area system 290 may be positioned on a dive boat or other surface-based location. In certain embodiments, the diver area system 290 includes a back-pack unit 292 and a console unit 294. Embodiments of a diver area system 290 are described in greater detail below with respect to FIG. 3. In one embodiment, the diver area system 292 includes a simulator application such as the simulator application 202. In certain embodiments, the simulator application 202.

As described herein, in certain embodiments, a user can initiate a simulation session using a client system 200, 210 which includes a simulation application 202, 212 which provides a simulation interface to the user. The client system 200, 210 communicates over the network 240 with the server system 250 to download certain components which define the virtual underwater environment, such as, for example, information relating to features (e.g., information relating to bathymetry and/or marine life) of a selected dive site. The client system 200, 210 uses information obtained from the server system and/or information stored locally on the client system 200, 210 to provide the user with a simulated virtual underwater environment for the selected dive site.

The virtual underwater environment can allow a user to simulate the experience of diving in actual locations (“dive sites”). For example, in certain embodiments, the information necessary to construct and simulate a dive site is stored on one or more databases such as the databases 230, 260, 270 and/or one or more computing systems such as the client system 200 and/or the server system 250. A computer, such as client computer 200, is configured to allow a user to simulate diving throughout a dive site. In certain embodiments, more than one computer is involved in the simulation process. For example, in some embodiments, the client computer 200 runs a simulation application program 202 while other computers, such as an application server 280, a storage server 220, or another client computer 210, provide certain information to the client computer 200 over the network 240 in order to run the application. For example, in certain embodiments, the server system 250 provides authentication information or other information to the client computer 200.

In an example embodiment, a user may download virtual dive site information to the diver area system 300, such as dive site map and terrain information. For example, a user may download a virtual dive site or a portion thereof to a client computer as described herein, such as to their personal computer, and simulate the dive site. Once the user has virtually explored the dive site on the simulator application, the user can download a portion of the dive site (e.g., map and/or terrain information) onto the diver area system 300. The dive site information may then be used to, for example, provide position information (e.g. their own position, the position of buddy divers, or the position of one or more surface based objects) to the user. In certain embodiments, the dive site information can be downloaded from, for example, the client system, over the Internet from a server system. In other embodiments, the dive site information may be provided on a storage medium such as a CD-ROM. In other embodiments, the user may not simulate the dive before performing the actual dive and may directly download the dive site information on the diver area system 300.

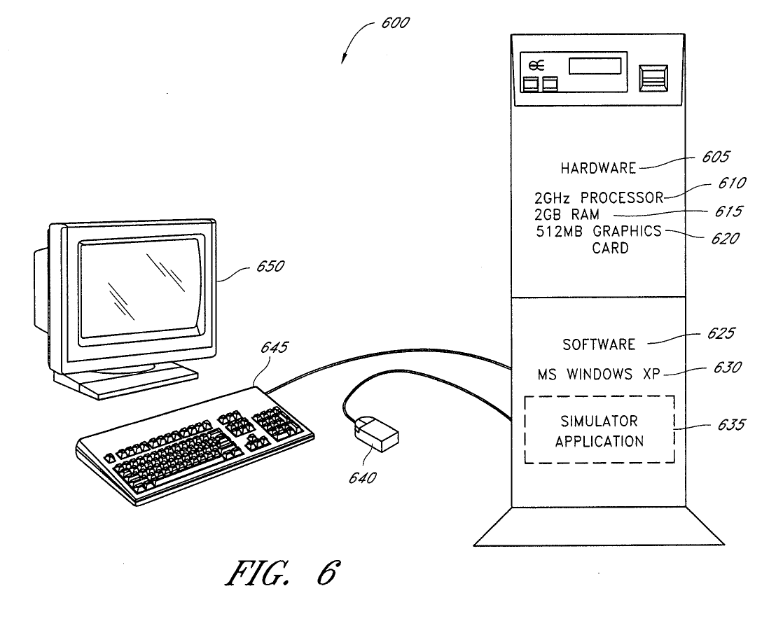

The various components of the underwater environment topology described with respect to FIG. 2 may be implemented on computing systems compatible with computing systems such as the computing system 200 described herein with respect to FIG. 6. For example, in certain embodiments, one or more of the client systems 200, 210, the application server 280, the storage server 220, and the diver area system 290 are implemented on a computing system 200 as described herein. In other embodiments, some other computing system may be used.

In certain embodiments, the simulation program is configured to generate the virtual underwater environment by utilizing information from a virtual underwater environment database, embodiments of which are described herein. In certain embodiments, the virtual environment database may comprise information on the server database 230, the client database 260, some other database, or any combination of thereof.

### II. Overview of a Diver Area System

FIG. 3 is a high-level diagram of an example diver-area system 300 in accordance with certain embodiments described herein. In certain embodiments, the diver area system 300 may allow users to navigate while diving in actual dive sites and/or improve the safety of the diving experience. For example, in certain embodiments, the diver area system may provide the user with his or her actual or relative location, the actual or relative location of other divers (or “buddies”), and/or the actual or relative location of a surface object (e.g., a dive boat). In certain embodiments, the diver area system 300 may provide the user's location relative to one or more buddies. In certain embodiments, the user can thus navigate intelligently throughout the actual dive site and/or track the location of buddies, which can improve dive safety and efficiency. In certain preferred embodiments, the diver area system 300 can include a backpack unit 320 and a console unit 310.

In certain embodiments, the diver area system 300 stores information relating to the dive, such as the path taken by the diver, such that the diver can review the actual dive in a replay mode. For example, the diver may be able to upload information relating to the dive to a simulator application and simulate the actual dive. In certain embodiments, the simulator application resides on a client system while in certain other embodiments it may reside somewhere else, such as, for example, on the diver area system 300 itself.

In certain embodiments, for example, portions of a dive site, information relating to a dive site, or an entire dive site may be stored on the diver area system 300. For example, one or more maps relating to a dive site can be stored on a diver area system 300. In one embodiment, the underwater map is a relatively low resolution contour only map with one-foot depth resolution. In other embodiments, the map may include more detail. For example, in certain embodiments, the map may include a 3D virtual representation similar to the simulation interface described herein. In certain embodiments, the diver area system 300 can display the map on the console unit 310. In certain embodiments, when the user is ready to begin an actual dive, they user will attach the backpack unit 320 to an air tank and take a console unit 320 along when entering the water. Once underwater, the diver can use the diver area system 300 for various purposes, including: a) navigating underwater, b) monitoring the status of equipment, c) monitoring the equipment of buddy or buddies; d) monitoring the position of a buddy or buddies; e) communicating with buddies, and f) communicating with the surface.

In certain embodiments, the diver area system 300 is configured to provide the diver knowledge of his or her absolute and relative underwater position. For example, the absolute position of the diver includes the current position of the diver with respect to the environment of the dive location, and the relative underwater position includes the current position of the diver with respect to one or more buddy divers. The map can be used together with other components to store a dive plan and to monitor the progress of the diver in achieving the diving plan. The diver area system 300 can be used to monitor the activities of the diver's buddy and therefore reduce the risk of separation between the diver and their buddy.

The backpack unit 320 of some embodiments is configured so as to be mountable on a standard air tank. For example, in one embodiment, the backpack unit 320 is a rectangular shaped unit that can be attached to a tank mounting bracket that attaches to the air tank (e.g., with screws). In some embodiments, the backpack unit is about the size of a standard pack of cigarettes or a deck of playing cards. Alternatively, the backpack unit 320 may be another size, may attach to another location on the diver, and may be attached using another mechanism, such as with one or more straps, a snug-fit rubber-coated bracket, or with an adhesive. In certain embodiments, the backpack unit 320 can include various functional blocks, such as, for example, a communication module 322, a map and navigation module 326, an inertial measurement module 324, and a dive function module 328. In certain embodiments, the backpack unit 320 performs a substantial amount of the processing of the diver area system 300.

The communication module 322 of certain embodiments allows for communication between the diver area system 300 and various other devices for various purposes. For example, the backpack unit 320 may communicate with the console unit 310 over link 340. In certain embodiments, the diver area system 300 may communicate with other diver area systems (e.g., of buddies) over the link 330. The diver area system 300 can communicate over the link 330 with one or more pieces of the diver's equipment in order to provide status information relating to the equipment. For example, in one embodiment, the diver area system can include an air pressure gauge rated at 5000 PSI that monitors air tank pressures and transmits signals indicating the same to provide information relating to the amount of air left in the tank. In certain embodiments, the communication module 322 allows the diver area system 300 to communicate with one or more surface-based systems over the link 332. The surface-based system may, in certain embodiments, comprise another diver area system 300, components thereof, or another type of system such as a client system. In certain embodiments, the backpack unit 320 utilizes communication methods, such as acoustic communication methods, which are described herein. The links 330, 332, 340 are shown as separate links for the purposes of illustration and are not intended to be limiting. For example, in certain embodiments, the links 330, 332, 340 may be implemented over a single physical link. For example, in certain embodiments, the communication module 322 communicates with the various other devices (e.g., a console unit 310, other diver area systems, etc.) using a packet based protocol over a single physical communication link but uses a unique device identifier when communicating with each device or type of device.

In one example embodiment, the communication module 322 includes an acoustic modem which includes a single integral electronics casing and a top mounted transducer which converts electrical signals from the modem into sound waves for underwater transmission. In one embodiment, the housing of the diver area system 300 accommodates the acoustic modem such that the transducer is exposed to water and the rest of the acoustic modem (e.g., the power and data connections) are in the housing of the diver area system 300. In one example embodiment, the modem, which may be a Micron Data Modem from Tritech International, is relatively small. For example, the modem may be between about 50 and 60 millimeters wide and between about 70 and 80 millimeters tall. The modem may be able to transmit about 40 bps spread spectrum over a standard frequency band of from between about 20-24 KHz. Optional frequency bands may include bands from about 16-20 KHz and 24-28 KHz. The transducer may be omni-directional with a maximum range of about 1 km. The transmitter source level may be about 169 dB re 1 uPa at 1 m. The modem may connect to the diver area system using an RS232 or RS485 interface. The modem may consume about 3.5 W when transmitting, 48 mW while in sleep mode, and 280 mW in standby mode. The modem may run on a 12-24V DC power supply and have a depth rating of 750 m. Those of ordinary skill will appreciate that the present invention is not limited by any particular acoustic modem. In certain embodiments, other types of acoustic modems may be used. In some embodiments, non-acoustic communication methods such as optical communication can be used.

The diver area system 300 of certain embodiments includes a motion tracking module capable of providing an indication of the movement and position of the diver. For example, the inertial measurement module 324 of certain embodiments senses the motion of the diver. In certain embodiments, the inertial measurement module 324 may be an inertial measurement unit (“IMU”). For example, in certain embodiments, the inertial measurement module 324 detects the type, rate and direction of the diver's motion and uses the information to track the position of the diver. In certain embodiments, the inertial measurement module 324 detects the movement of the diver in the X, Y and Z directions. In certain embodiments, the diver area system 300 includes a digital signal processor which receives as input the data from various sensors included in the inertial measurement unit 324. For example, the sensors may include accelerometers, gyroscopes, depth sensors, water speed sensors, and magnetic field sensors in certain embodiments. In various embodiments, some of these sensors may be included in the inertial measurement module 324 and some may be included in another portion of the diver area system 300. For example, the inertial measurement module 324 of certain embodiments includes three accelerometers and three gyroscopes. The accelerometers in some embodiments are positioned orthogonal to each other and measure the inertial acceleration of the diver. In one exemplary embodiment of the present invention, an IMU combines three axes of angular rate sensing and three axes of acceleration sensing to provide full six-degrees-of-freedom motion measurement. In this embodiment, the IMU, which may be an ADIS16355 model from Analog Devices, uses a tri-axis gyro rated at plus/minus 300 degrees/second and a tri-axis accelerometer rated at plus/minus 10 g. The IMU may occupy one cubic inch and use a 5-volt power supply and a 4-wire serial peripheral interface and include six output data registers that each provide 14-bit values representing X-axis gyroscope output, Y-axis gyroscope output, Z-axis gyroscope output, X-axis acceleration output, Y-axis acceleration output and Z-axis acceleration output. The IMU may have programmable characteristics including sample rate which may be set via writing a value to a control register to up to approximately 800 samples per second. Those of ordinary skill will appreciate that lower sample rates may lower power dissipation. Those of ordinary skill will also appreciate that the present invention is not limited by any particular IMU. In certain embodiments, other position indication methods may be implemented, such as, for example, systems incorporating GPS technology. For example, one embodiment uses a series of GPS buoys which are combined with acoustic communication to provide position indication.

A map and navigation module 326 of certain embodiments receives motion and/or position data from the inertial measurement unit 324 and correlates the data with one or more maps of the dive site on the diver area system 300. For example, in certain embodiments, the map and navigation module 326 may use the motion and/or position data received by the inertial measurement unit 324 in order to provide the position of the diver within the dive site and the relative position of a diver with respect to one or more buddy divers or a surface-based object (e.g., a boat). In certain embodiments, the map and navigation unit 326 uses the position information to provide information placing the diver within the map of the dive site on the diver area system 300. The inertial measurement module 324 and the map and navigation module 326 may be GPS assisted in certain embodiments. In certain embodiments, the inertial measurement module 324 and the map and navigation unit can be initialized, manually or with GPS assistance, with a pre-set location. The pre-set location information may be included, for example, in a digital map of the dive site loaded onto the diver area system 300. In certain embodiments, the GPS assistance and/or pre-set location information can aid the position calculation.

In certain embodiments, a dive function module 328 calculates other information related to the dive such as depth, temperature, air remaining, air pressure, no decompression limit time, residual nitrogen time, time elapsed, etc. Additional information may be provided in various embodiments. Those of ordinary skill will appreciate that dive computers are known which perform such calculations based on existing gauges. Those of ordinary skill will further appreciate that calculated values may be represented in data packets and transmitted in a network topology.

The information from the various modules including the communication module 322, the map and navigation module 326, the inertial measurement module 324, and the dive function module 328 may be, in certain embodiments, communicated over the link 340 to the console unit 310 for display to the user on the output module 316, described herein.

The console unit 310 of certain embodiments is configured to be attachable to and generally viewable by the diver. In certain embodiments, the console unit 314 provides a substantial amount of the user interface functionality of the diver area system 300. For example, the console unit 310 is either wrist mounted or handheld by the diver in certain embodiments. In some embodiments, the console unit 310 fits into a holster which may be mountable on the diver, such as on the divers waist, and the console unit 310 can be stored in the holster when not in use. In certain embodiments, the console unit 310 is wirelessly connected to the backpack unit 320 and allows the user to, for example: a) access backpack unit; b) view dive site information such as a dive site map or graphical view; and c) view the position of the diver (e.g., within a dive site map) and/or the position of his buddies, and d) exchange messages with their buddy or buddies and/or a surface-based object.

The console unit 310 can include an input module 312, a communication module 314, an output module 316, and a map generation module 318, for example. In certain embodiments, the communication module 314 implements a bi-directional wireless communication link 340 between the console unit 310 and the backpack unit 320. In certain embodiments, the communication module utilizes communication methods, such as acoustic communication methods, which are described herein. The input module 312 can accept input from the user. For example, the input module 312 may include a keyboard, buttons, a writing interface for use with a stylus, or some other user input interface. The input module 312 of certain embodiments may include a microphone which can receive audio input from the diver. In certain embodiments, the microphone is not co-located with the console unit 310. For example, in certain embodiments, the microphone is located in the diver's mask.

The console unit 310 of certain embodiments also includes a map generation module 318 that generates information relating to the position information of the diver with respect to the dive site and to a position with respect to buddy or buddies which can be received over the link 340 from the backpack unit 320. In certain embodiments, the map generation module 318 receives input from the inertial measurement module 324 and the map and navigation module 326. In certain embodiments, the information generated by the map generation module 318 is sent to the output module to display the positional information to the diver.

The output module 316 of certain embodiments includes a display, such as, for example, an LCD display, which can display information such as a rendering of the dive site. In certain embodiments, the display shows a bird's eye contour map of the dive site including, for example, the location of the user and/or buddies in the dive site. In certain other embodiments, the display includes a 3D virtual representation of the dive site as the user navigates through the dive site. For example, the 3D representation may be similar to the simulation view described herein with respect to the simulator application. The output module 316 may also include a speaker in certain embodiments. In certain embodiments, the speaker is not physically co-located with the console unit. For example, the speaker can be included in the diver's mask. The console unit 310 may also include mechanisms to attract the user's attention when, for example, a safety concern is present. Such mechanisms can include, for example, flashing lights, speakers which can create audio warnings such as high-pitched beeps, and devices which can cause vibrations to alert the diver. For example, in one embodiment, if the diver area system 300 detects that the diver is running low on available air, the system may activate the alert mechanism.

In various embodiments, the processing associated with generating the rendering of the dive site for display on the console unit 310 may be accomplished by the map and navigation module 326 of the backpack unit 320, the map generation module 318 of the console unit 310, the output module 316 of the console unit 310, or any combination thereof. For example, in one embodiment, a 3D rendering is presented on the display and a substantial portion of the rendering processing is performed by the map generation module 318 of the console unit 310. In another embodiment, a substantial portion of the processing is performed on the backpack unit 320 by, for example, the map and navigation module 1126 and is then transmitted to the console unit 310 for further processing and display.

Embodiments of the diver area system 300 also include a power source (not shown). For example, the backpack unit 320 and the console unit 310 may include separate battery packs in certain embodiments. In other embodiments, the console unit 310 is powered by the backpack unit 320 or vice versa.

In certain embodiments, the diver area system 300 and associated modules may be implemented on a computing system including various hardware modules. For example, the exemplary diver area system includes one or more central processing units (“CPU”), which may include a conventional microprocessor. In various embodiments, the CPUs may include a conventional general purpose single-chip, multi-chip, single core or multiple core microprocessor such as a Pentium® processor, a Pentium® II processor, a Pentium® Pro processor, an xx86 processor, an 8051 processor, a MIPS® processor, a Power PC® processor, or an ALPHA® processor. In addition, the microprocessor may be any conventional special purpose microprocessor such as a digital signal processor.

The diver area system 300 further includes a memory, such as random access memory (“RAM”) for temporary storage of information. In certain embodiments, the diver area system 300 further includes a read only memory (“ROM”) for non-volatile storage of information, and a mass storage device, such as a hard drive, solid state memory, diskette, or optical media storage device.

The example diver area system 300 includes one or more commonly available input/output (I/O) devices and interfaces, such as a keyboard or touchpad. In one embodiment, the I/O devices and interfaces include a display device, such as a monitor that allows the visual presentation of data to a user. The display device provides for the presentation of GUIs and application software data, for example. The diver area system 300 may also include one or more multimedia devices, such as speakers, and microphones, for example.

The diver area system 300 can, in some embodiments, include a graphics card (also referred to as a video card, graphics accelerator card, etc.) which generally outputs images to the display. In certain other embodiments the graphics card may be integrated on the motherboard.

The diver area system 300 also includes various software modules. For example, the diver area system 300 includes an operating system such as: Microsoft® Windows® 3.X, Microsoft® Windows 95, Microsoft® Windows 98, Microsoft® Windows® NT, Microsoft® XP, Microsoft® Vista, Microsoft® Windows® CE, Palm Pilot OS, OS/2, Apple® MacOS®, Disk Operating System (DOS), UNIX, Linux®, VxWorks, or IBM® OS/2®, Sun OS, Solaris OS, IRIX OS operating systems, and so forth.

The diver area system 300 can also include software which implements portions of the functions or modules of the diver area system described above. The software can be executed by the one or more CPUs and includes, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In certain embodiments, where the backpack unit 320 and console unit 310 are separate physical units, for example, the computing system and associated hardware and software components which comprise the diver area system, 300 are distributed amongst the backpack unit 320 and the console unit 310. In some embodiments, for example, both the backpack unit 320 and the console unit 310 include separate processors, memory, I/O devices, etc.

Although disclosed with respect to the embodiments of FIG. 3, artisans will recognize from the disclosure herein various alternative embodiments. For example, in some embodiments, the functions of the backpack unit 320 and the console unit 310 are incorporated into one integral unit. In other embodiments, one or more of the functions of the console unit 310 and/or the backpack unit 320 are performed by the other unit. For example, in certain embodiments, the function of the map generation module is performed by the backpack unit 320. In certain embodiments, the communication between the console unit 310 and the backpack unit 320 is not wireless, but is over a wired connection, such as, for example, an Ethernet, USB, or other type of connection. In embodiments having wired connections, the cable connecting the backpack unit 320 and console unit 310 can be sewn into the wetsuit or rooted through a neoprene conduit (or other passage) integral to, formed into or attachable to the wetsuit. This configuration can prevent the diver from becoming entangled in the cable.

In some embodiments, the console unit and associated display are integral in the diver's mask and is generally visible to the diver at all times. In certain embodiments, some of the calculations described with respect to the diver area system 300 are performed by remote devices and are provided to the diver area system 300 over one or more of the links 330, 332. In certain embodiments, the components of the diver area system 300 are incorporated along with components and functions which are typically included on existing dive computers. In certain embodiments, for example, the diver area system 300 includes elapsed dive time, depth, non-decompression time, compass, air remaining, and air consumption information.

### III. Example Embodiments of Diver-Area, Buddy-Area, and Site-Area Networks

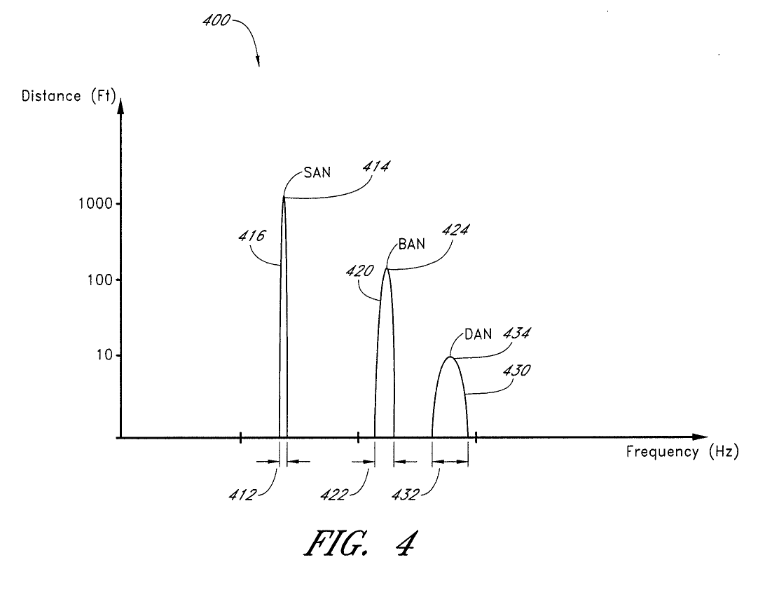

FIG. 4 is a chart 400 showing operating characteristics of example DAN 430, BAN 420, and SANs 410 of an example underwater environment communication and navigation system in accordance with certain embodiments described herein. As shown, the three networks operate on non-overlapping frequencies. The DAN 430 of the example embodiment has a 32 KHz bandwidth with a center frequency of 500 KHz. The BAN 420 of the example embodiment has a bandwidth of 24 KHz and a center operating frequency of 180 KHz. The SAN 410 of the example embodiment has a 12 KHz bandwidth and a center frequency of 60 KHz. The example DAN 430, BAN 420, and SAN 410 have ranges of approximately 2, 30, and 300 meters respectively. As shown, the bandwidth of the networks generally decreases with increasing distance in the example embodiment. Artisans will recognized from the disclosure herein that, certain alternative embodiments exist having different DAN, BAN and SAN operating characteristics.

In certain embodiments, the console unit allows the diver to program, operate and monitor diving equipment and peripherals. The console unit of some embodiments shall communicate directly with the backpack unit. For example, using the console unit and/or backpack unit, the diver can: a) monitor personal data (e.g., air left, breathing rate, depth, temperature, dive time left, etc.); b) monitor position on one or more maps displayed on the console unit; c) monitor information relating to one or more buddies (e.g., air left, depth, temperature, dive time left, etc.); d) monitor buddy position on one or more maps displayed on the console unit; e) initiate, terminate, and/or respond to an SOS; f) communicate with buddies and/or other divers; and g) communicate with surface-based objects and individuals. In certain embodiments, the communication between the console unit and the backpack unit is bi-directional. The data rate, frequency, and priority can depend on certain variables such as what type of activity or situation is involved. In certain embodiments, some or all of the information on the diver area system transmitted from the backpack unit to the console for display.

Example Embodiments of a Diver Area Network

The DAN may, in certain embodiments, be described as an un-tethered area network. In certain embodiments, the DAN is less than approximately 6 feet in all directions from the diver. The DAN of various embodiments enables communication between the backpack unit, the console unit, and certain diving equipment. In certain embodiments, the DAN is configured such that the DAN operates generally without interruption when multiple divers are in close proximity to each other and are using diver area systems. For example, in certain embodiments, DANs are generally configured to be invisible to each other. For example, through the use of specifically addressed data packets, each individual DAN recognizes its own peripherals and communicates with those peripherals and not with the peripherals of another DAN. In certain embodiments, the DAN is configured to operate both underwater and on the surface.

A DAN allows a diver to check personal dive related data in certain embodiments. In general, a diver normally may check his diver area system every few minutes or at longer intervals. However, a diver may check his diver area system more frequently under certain circumstances, such as when the diver is monitoring rate of ascent, depth, or heading. In certain embodiments, the console unit is updated as appropriate with the personal dive related data, such as, for example, information relating to his equipment and peripherals. For example, in one embodiment, the console unit is updated when the backpack unit detects a significant change with respect to a particular variable, such as when the diver has moved certain distance in a relatively short period of time. In certain preferred embodiments, the maximum update frequency is 1 Hz and the minimum update frequency is 0.1 Hz. In other embodiments, the console unit may be updated more or less frequently. In certain embodiments, a DAN data packet defining equipment or peripheral information includes a backpack MAC address, a console MAC address, and dive information (e.g., air left, breathing rate, depth, temperature, etc.). In certain embodiments, the data packets may comprise other information, be organized differently, or be of variable content and/or length.

The DAN allows a diver to monitor position on a dive site map in certain embodiments. The determination of position, including the correlation of the position to the map, can be performed in the backpack unit of the diver area system as described herein. In certain embodiments, the underwater map being explored can be transferred from the backpack to the console before initiating the dive. This pre-dive transfer of the map can limit underwater network traffic. In one embodiment, the underwater map is a low resolution contour map with one-foot depth resolution. The diver position information can include 3-dimensional coordinate information (e.g., two coordinates defining the bird's eye location and a third coordinate defining the depth) relative to the map, and pitch, roll and bearing data, in various embodiments.

In certain embodiments, the diver area system includes an SOS button. For example, the SOS Button can be a simple ON/OFF red button. In one embodiment, the SOS button is clipped to his BCD (Buoyancy Compensation Device). In other embodiments, the SOS button is included on the console unit or somewhere else on the diver's person. The SOS button may be actuated in certain embodiments when the diver encounters an emergency situation while underwater (e.g., becomes entangled and immobile, has equipment issues, becomes lost, is running out of air, etc.). In such circumstances, the diver can press the SOS button in order to actuate it. The SOS button in certain embodiments will communicate the change of state to the backpack unit, which can then take a specified action. For example, the backpack unit can then initiate an SOS call. Once the emergency situation is addressed, the button can be deactivated, for example, by pressing the button again. In certain other embodiments, the SOS button is not a button but is a switch or other mechanism. In some embodiments, the SOS button has more than one state. For example, in one embodiment, the SOS button can indicate various levels of danger.

In certain embodiments, a camera synchronizer can be integrated into an underwater camera housing which may be part of the diver area system. The camera synchronizer allows the diver to automatically mark on the map a point of interest. For example, the camera synchronizer can signal the event to the backpack unit, which can log the point of interest picture in the “bubble trail” along with the position where the picture was taken. In various embodiments, the diver area system can also include various biological sensors, such as a heart monitor, which can help monitor the health of the diver and anticipate, detect, and reduce occurrences of panic. Periodically, throughout a dive, the biological sensors may be polled and the output saved to a diver health log memory and thus provide a record of changes in diver health or physiology throughout a dive. This information may be correlated time wise (through synchronized time-stamps for example) with physical events during the dive such as ascents, descents, traversals at various speeds and so on. Divers may thus learn which dive activities stress individual physiology in particular ways and learn to avoid particularly stressful conditions.

In certain embodiments, the DAN uses a packet based protocol in which each packet has a corresponding acknowledged/not acknowledged field. In one embodiment, the cumulative max aggregated data rate for the DAN including ACK/NAK is approximately 32 Kbps. To avoid communication noise, interference, and narrowband jammers, physical layer device employed by the DAN in certain embodiments may be broadband and capable of supporting at least 64 Kbps over a MAC having at least 50% efficiency. In various embodiments, ad hoc higher layer protocols and messaging structures can be employed to reduce the data requirements. For example, such mechanisms can be used to avoid having to send MAC addresses multiple times.

Example Embodiments of a Buddy Area Network

The BAN of certain embodiments also allows a diver to monitor data relating to the equipment or peripherals of one or more buddies within the dive site (e.g., air left, breathing rate, depth, temperature, dive time left, etc.). In certain embodiments, the buddy data is received by the backpack unit over the BAN (or SAN) upon request by the user. The buddy data may then be transmitted from the backpack unit to the console unit (e.g. over a DAN) for display. In certain embodiments, certain buddy data may be received directly by the console unit and may be transmitted periodically without specific request by the user. In other embodiments, the console unit may be updated more or less frequently.

In certain embodiments, the BAN allows the diver to monitor the position of one or more buddies on the dive map. For example, the backpack unit receives and/or determines buddy position and attitude information from the buddy's backpack unit over the BAN (or SAN). The position information can then be transmitted from the backpack unit to the console over the DAN for display. In one embodiment, 10 buddies can be tracked concurrently. In other embodiments, more or less buddies may be tracked over the BAN.

In certain embodiments, the console unit is updated from between 5 seconds and 20 seconds with data from buddy divers including, for example, buddy position information and buddy status such as buddy equipment and peripheral data. In certain embodiments, communications intended for buddies and is transmitted from between every 5 seconds and every 10 seconds maximum. In other embodiments, higher and lower update frequencies may be used. In one embodiment, for example, an emergency or SOS mode can be set such that the frequency of updates occurs every second.

In certain embodiments, the BAN allows a user to communicate with buddy divers. For example, the console unit of certain embodiments can be used to exchange text messages with a buddy over the BAN network. In on embodiment, the amount of underwater typing is reduced by pre-setting certain commonly used messages (e.g., “Time to head back”) in the console and/or by allowing for broadcast messages to multiple divers.

In certain embodiments, the BAN is an un-tethered area network which does not interfere with the DAN or the SAN and does not appreciably reduce the bandwidth of the DAN or the SAN. The BAN of certain embodiments has a physical reach of up to approximately 100 feet in all directions. In certain embodiments, the BAN hardware is mounted in each diver's backpack unit. In other embodiments, the reach is greater than 100 feet. In certain embodiments, the logical reach of the BAN may be extended beyond 100 feet. For example, a mesh protocol can be used to extend the logical reach of the BAN. For example, a first diver communicating with a second diver over a first physical BAN may enter a region covered by a second BAN in which a third and fourth diver are communicating. In such a situation, the two BANs can be “meshed” together such that the second BAN is available to the first and second divers and the first BAN is available to the third and fourth divers. In certain embodiments, the “meshed” BAN would not be available for standard communications but may only be available for specific communications such as emergency communications. For example, the second BAN would not be available to the first and second divers in certain embodiments except for purposes of communicating SOS messages. For the example embodiment where each BAN has a physical range of 100 feet, the logical range of the “meshed” BAN would be up to approximately 200 feet depending on the relative locations of the divers.

The meshing of BANs may not only extend the logical range but may allow divers to perform other tasks such as communicating around obstacles. For example, if a reef or other large object is in between two buddies and a non-buddy diver is in between them but above the reef such that the reef is not between the non-buddy diver and either of the buddies, the two buddies may still be able to communicate by meshing together their own BAN and the BAN of the non-buddy diver. In certain embodiments, the mesh protocol of the BAN is configured to handle more than one hop. For example, in one embodiment, BANs can be logically extended up to three hops. In certain embodiments, the SAN can be configured to take over communications if a buddy is not within a certain range. For example, in various embodiments, the SAN will take over communications from the BAN if a buddy is not within the physical range of the BAN or is more than a specified number of hops away in a “meshed” BAN arrangement. In certain preferred embodiments, the BAN employs a MAC protocol which can handle up to 128 divers concurrently. In certain other embodiments, more or less divers may be supported by the protocol.

In certain embodiments, the BAN employs a packet-based protocol. In one embodiment, a BAN data packet includes a MAC diver source, a MAC diver destination, position/attitude information and personal information. In some embodiments, some of the information might be omitted from the packet if no change with respect to a previous transmission (e.g., when a buddy diver has not moved). In certain embodiments, each packet has a corresponding ACK/NAK. In one preferred embodiment, the BAN has a physical layer data rate of approximately 52 Kbps.

Certain embodiments of the BAN include an SOS mode of operation of certain in which packets generated by the diver area system of the diver or divers requesting the SOS and packets generated by the diver area system of the diver or divers responding to the SOS have a higher priority in the network protocol. In certain embodiments, divers in a better position to assist the distressed diver, such as divers who are closest to the diver, are given a higher priority in the BAN. In one embodiment, the SOS packets from the requesting diver are broadcasted to the other divers periodically (e.g., every 5 seconds) until a message indicating that the SOS has been received and is being responded to is received. In one embodiment, once the response is received, the SOS signal is transmitted less frequently (e.g., every 10 seconds).

Example Embodiments of a Site Area Network

The SAN of certain embodiments is an un-tethered area network allowing divers to communicate over a site area network (“SAN”) with one or more surface-based objects and/or other divers. In certain embodiments, the SAN is used in SOS (e.g., emergency and search and rescue) situations and enables communication between divers and other divers and/or between divers and a surface vessel. In one embodiment, the SAN is primarily used for emergency situations and is inactive (e.g., in listening mode) in non-emergency situations.

In certain embodiments, the SAN has a range of about 500 feet, but the logical reach of the SAN may be extended in certain embodiments via a mesh protocol. For example, the mesh protocol may be similar to the BAN mesh protocol described above. In certain preferred embodiments, the physical layer of the SAN does not interfere with the physical layers of the BAN or the PAN. In certain embodiments, the SAN hardware is mounted on the diver's backpack unit and on the surface-based object. In certain embodiments, the hardware that implements the SAN is similar to the hardware that operates the DAN and the BAN. For example, in one embodiment, the diver area system on a particular diver provides the DAN, BAN, and SAN hardware capabilities with respect to that diver.

In one embodiment, the SAN supports communication with 256 divers in a dive site. In other embodiments, more or less divers can be supported. In one embodiment, the SAN can be extended via a mesh protocol up to 3 hops. In one embodiment, the SAN supports a certain number of victim divers and a certain number of rescuer divers concurrently. For example, up to 10 victim divers and 30 rescuer divers may be supported in one embodiment. In certain embodiments, the SAN includes an SOS mode. The SOS mode can be initiated manually by the requesting diver or automatically by the diver area system when it detects a particular condition with respect to the diver (e.g., heart attack, panic conditions, unconsciousness, etc.). In one embodiment, the SOS packets from the requesting diver are broadcasted to the other divers periodically (e.g., every 5 seconds) until a message indicating that the SOS has been received and is being responded to is received. In one embodiment, once the response is received, the SOS signal is transmitted less frequently (e.g., every 10 seconds).

In certain embodiments, the SAN employs a packet-based protocol. The data packets of certain embodiments include: a MAC diver source, MAC diver destination (e.g., broadcast), a MAC victim, position/attitude information, and personal information regarding the sender. In certain embodiments, some information is omitted if there is no change in state (e.g. position data may only be sent the sending diver has moved). In certain embodiment, in SOS mode a rescuer can accept and respond (e.g., using the console unit) to the SOS request from the victim. The rescuer can then establish, via the SAN, a direct link with the victim. In one embodiment, messages are exchanged between victim(s) and rescuer(s) every 10 seconds.

A search mode is provided in certain SAN embodiments. For example, a SAN can allow a search to be performed for a buddy that is outside the range of the BAN. In one embodiment, once the buddy has been located within the SAN, the buddies can keep communicating their respective positions using the SAN until they re-enter the BAN range. The search mode may be initiated manually or automatically when the diver falls out of range of the BAN, for example. The search mode can be terminated manually or automatically.

In certain embodiments, a diver could use the SAN to exchange text messages with the surface vessel and/or with any other system which can communicate with the surface object. For example, the diver can communicate a text message to the SAN which can in turn communicate the text message to another person over an Internet connection or via a cell phone connection. In certain embodiments, other types of communication, such as voice communication, can be used.

While at the surface, the user can, in certain embodiments, accomplish various tasks using the underwater navigation and communication system. For example, in certain embodiments, the user can monitor and/or program his equipment, download dive site maps, add or delete buddies to and from his buddy list, review previous diving activities, plan for and/or log their dives.

In certain embodiments, two types of networks are implemented at the surface: 1) a surface DAN, which can be similar to the underwater DANs described herein. For example, in certain embodiments, one diver area system implements both the surface DAN and the underwater DAN. The surface DAN may be used to program the dive equipment, for example; and 2) a surface WLAN that can be used to access Internet and/or other LANs from the surface. The WLAN may be used, for example, to download dive site information onto the diver area system. In one embodiment, the WLAN is implemented on the backpack unit and conforms to IEEE 802.11b/g standards. In one embodiment, the WLAN can be enabled and disabled using the console unit.

In certain embodiments, one or more of the DAN, BAN, and SAN employ a carrier sense multiple access with collision avoidance network control protocol. In certain embodiments, the control protocol has approximately 50 percent efficiency. In other embodiments, different control protocols may be employed having different efficiencies.

In certain embodiments, the DAN, BAN, and SAN employ packet-based protocols. In certain embodiments, data packets include a MAC diver source, a MAC diver destination, and payload information (e.g., personal dive related information, buddy positional information, SOS messages, etc.). In some embodiments, some of the information might be omitted from the packet if no change with respect to a previous transmission (e.g., when a buddy diver has not moved). In certain embodiments, each packet has a corresponding ACK/NAK. Artisans will recognize from the disclosure herein that various alternatives embodiments exist.

Although the DAN, BAN, and SAN have been described with respect to preferred embodiments, artisans will recognize alternatives from the disclosure provided herein. For example, one or more of the DAN, BAN and SAN may, in certain embodiments, not be separate networks but may be integrated into one network topology. In certain other embodiments, the devices on which the DAN, BAN, and SAN are implemented may be different.

### IV. Virtual Underwater Environment Overview

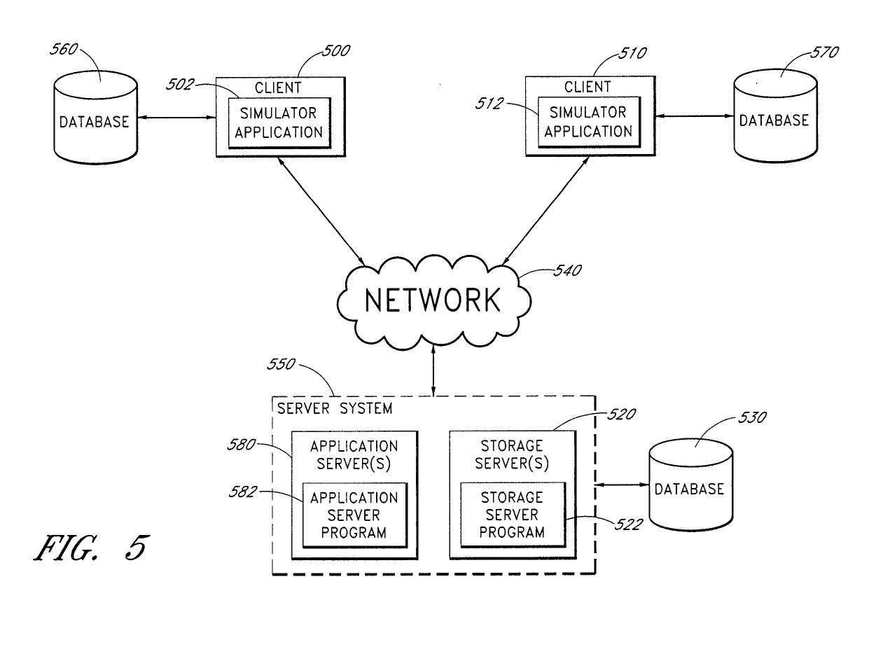

In certain embodiments, the virtual underwater environment can be used in a system similar to the one illustrated in FIG. 5, which illustrates an example topology on which a virtual underwater environment can be implemented in accordance with certain embodiments described herein. In one embodiment, one or more client systems 500, 510 communicate via a network 540 with a server system 550, which communicates with an underwater environment database 530. There may be any number of client 500, 510 and server 550 systems. In the illustrated embodiment, the client 500, 510 and server 550 systems are computer systems. In other embodiments, the client 500, 510 and server 550 systems may be other types of devices, such as, for example, mobile devices. In some embodiments, the client 500, 510 and server 550 systems may be any combination of different types of devices. For example, in one embodiment, some of the client systems 500, 510 may be computer systems, some may be mobile devices, and the server system 550 system may be a computer system. The client system 500 may, in certain embodiments, be a virtual underwater environment user's personal computer. In certain other embodiments, the client system 500 can be a computer, a cell phone, a personal digital assistant, a kiosk, Blackberry® device, a game console, or an audio player, for example.

In some embodiments, server system 550 maintains the database 530 which includes some or all of the data which defines the virtual underwater environment. In certain embodiments, the server system 550 includes a storage server 520 and an application server 580. In certain other embodiments, the functions of the storage 520 and application 580 servers of server system 550 are included in one server. In certain embodiments, for example, the client systems, 500, 510 also include a database 560, 570 which may comprise some or all of the data which defines the virtual underwater environment. In certain embodiments, for example, portions of the environment database are included on the client databases 560, 570 and portions of the environment are included on the server database 530. The illustrated example is just one embodiment of a topology in which a virtual underwater environment system may be implemented. In some embodiments, for example, the server system 550 and database 530 may not be included in the network topology and client systems 500, 510 can provide the virtual underwater environment to a user without the server system 550 or the database 530.

As will be described in greater detail below, in certain embodiments, a user can initiate a simulation session using a client system 500, 510 which includes a simulation application 502, 512 which provides a simulation interface to the user. In certain embodiments, the client system 500, 510 communicates over the network 540 with the server system 550 to download certain components which define and/or represent aspects of the underwater environment, such as, for example, information relating to features of a selected dive site (e.g., information relating to dive site bathymetry and/or marine life). In certain embodiments, the client system 500 uses information obtained from the server system and/or information stored locally on the client system 500 to provide the user with a simulated virtual underwater environment for the selected dive site. In certain embodiments, a user can interact with other users using the virtual underwater environment using embodiments described herein. For example, multiple users may dive concurrently in an on-line configuration (e.g., over the Internet) in the virtual underwater environment. Users can also interact with one another (e.g., by headset, keyboard, etc.) in certain embodiments when virtually diving with other users. Users may also communicate by attaching items to the locations in the underwater environment (e.g., text, images, etc.) as described in greater detail below.

The virtual underwater environment can, in certain embodiments, allow a user to experience, through visually realistic simulation, diving in actual locations (“dive sites”). For example, in certain embodiments, the information necessary to construct and simulate a virtual dive site is stored on one or more databases, such as the databases 530, 560, 570, and/or one or more computing systems, such as the client system 500 and/or the server system 550. A computer, such as client computer 500, is configured to allow a user to simulate diving in a dive site. In certain embodiments, more than one computer is involved in the simulation process. For example, in some embodiments, the client computer 500 runs a simulator application program 502 while other computers, such as an application server 580, a storage server 520, or another client computer 510, provide certain information to the client computer 500 over the network 540 that is used by or that facilitates the simulation application. For example, in certain embodiments, the server system 550 provides authentication information to the client computer 500.

In certain embodiments, the use of various components of the underwater environment is fee-based. For example, in certain embodiments, a user may incur a charge for downloading and/or using a dive site. In one embodiment, for example, a user purchases “air credits” which are consumed as the user explores the virtual environment. In one embodiment a user cam lease or rent a portion of the dive site. When the user leases or rents a portion of the three dimensional digital representation of the dive site, for example, he can become a “Reef Master” of that portion of the dive site. The user can then manage it by obtaining the permission and tools to interact with his portion of the dive site. In certain embodiments the user is allowed to improve and/or add to the dive site. For example, the user can add to the 3D models of the marine life typically populating the real dive site or to the terrain characteristics of the dive site. In certain embodiments, the fee-based structure can allow users to exchange rights with one another. For example, in certain embodiments, users can earn, exchange, and consume rights. In one embodiment, for example, when a second user visits a portion of the dive site managed by a “Reef Master”, a portion of the “air credits” consumed by the second user are credited to the Reef Master.

In certain embodiments, advertisements are presented by the virtual underwater environment. For example, the server system 550 can provide advertisements, such as banner advertisements, to the client 500 for display by the simulator application 502. In various embodiments, static advertisements. such as image and text advertisements, and dynamic advertisements, such as videos, sound, and animations, can be displayed by the simulator application 502. In various embodiments, the advertisements can be displayed during various stages of a virtual diving session on the simulator application 502. For example, advertisements can be displayed during startup, such as when a virtual dive site map is being downloaded from the server. The advertisements can also be displayed throughout the virtual diving session through the simulation interface, such as a simulation interface described herein. For example, a banner may pop-up on the display. The advertisements may also be integrated into the virtual diving scene during the simulation. For example, a boat in the virtual dive scene may have an advertisement attached to it. In some embodiments, advertisements may be displayed when the user exits the simulation session. For example, in one, embodiment, a screen may be displayed indicating that the simulation session was supported by a certain sponsor.

In some embodiments, advertising content is delivered based on certain criteria. The criteria can, for example, tailor the delivery of the advertising content to meet the needs of the client and enhance the effectiveness of the advertising. For example, advertising may be directed towards certain users based on user attributes such as the type of equipment they selected, the physical characteristics of the user, certain preferences selected by the user. For example, in one embodiment, when a user selects a particular type or brand of wet suit, advertisements relating to that brand of wet suit will be delivered to the user through the simulator application 502. In certain embodiments, delivery of the advertisements may be based on the location of the user within the dive site. For example, in some embodiments, when the user is within a certain distance of a given landmark, or is on the surface, they will receive advertisements. In certain embodiments, the user will receive certain types of advertisements based on the type of landmark, the location of the dive site, etc. In one embodiment, for example, advertisements for businesses in proximity to the dive site are presented to the user. In one embodiment, advertisements are directed towards the user based on the characteristics of the dive site. These characteristics may be characteristics of the actual dive site (e.g., current weather conditions, geographic location of the dive site), or based on user defined characteristics (e.g., user determined water temperature). In certain embodiments, the frequency at which particular advertisements are presented to the user can be varied by the simulator application 502 and/or the entity serving the advertisements to the simulator application 502, such as the server system 550 or some other server.

In certain embodiments, the server system 550 or some other server, such as a Web server, can track metrics associated with the advertisement. In various embodiments, for example, quantities for the following types of activities can be tracked: 1) exposures to a specific audience (“impressions”); 2) deliveries of a targeted visitor to an advertiser's website; 3) clicks on advertisements re-directed visitors to the advertiser's website. In certain embodiments, other metrics may be used. In certain embodiments, advertiser's pay based on certain metrics such as, for example, the metrics described above. For example, in some embodiments, an advertiser will pay a certain amount for every thousand impressions or for every click through and re-direction. In various embodiments, as will be appreciated by those of skill of the art from the disclosure herein, other forms of advertising may be possible using the virtual underwater environment.

In certain embodiments, the simulation application 502 is configured to generate the virtual underwater environment by utilizing information from a virtual underwater environment database, embodiments of which are described herein. In certain embodiments, the virtual environment database may comprise information on the server database 530, the client database 560, some other database, or any combination of thereof.

FIG. 6 illustrates a high-level diagram of an example computing system 600 on which components of a virtual underwater environment may be implemented in accordance with certain embodiments described herein. For example, in certain embodiments, one or more of the client systems 200, 500 the application servers 280, 580, and the storage servers 220, 520 are implemented on a computing system 600 as described herein.

In certain embodiments, the computing system 600 includes, for example, a personal computer. The computing system 600 includes various hardware modules 605. For example, the exemplary computing system 600 includes a central processing unit (“CPU”), which may include a conventional microprocessor. As shown, in one embodiment, the processor can comprise a 2 GHz processor 610. In various embodiments, computing systems described herein, such as computing system 600, may include a conventional general purpose single-chip, multi-chip, single core or multiple core microprocessor such as a Pentium® processor, a Pentium® II processor, a Pentium® Pro processor, an xx86 processor, an 8051 processor, a MIPS® processor, a Power PC® processor, or an ALPHA® processor. In addition, the microprocessor may be any conventional special purpose microprocessor such as a digital signal processor.

The computing system 600 further includes a memory, such as random access memory (“RAM”) for temporary storage of information. As shown, in one embodiment, the memory comprises a 2 GB RAM 615. In certain embodiments, the computing system 600 further includes a read only memory (“ROM”) for non-volatile storage of information, and a mass storage device, such as a hard drive, solid state memory, diskette, or optical media storage device.

The example computing system 600 includes one or more commonly available input/output (I/O) devices and interfaces, such as a keyboard 645, mouse 640, touchpad, or printer. In one embodiment, the I/O devices and interfaces include a display device, such as a monitor 650 that allows the visual presentation of data to a user. The display device provides for the presentation of GUIs and application software data, for example. The computing system 600 may also include one or more multimedia devices, such as speakers, and microphones, for example.

The computing system 600 preferably includes a graphics card, such as the 512 MB graphics card 620 (also referred to as a video card, graphics accelerator card, etc.) which generally outputs images to the display. In certain other embodiments the graphics card may be integrated on the motherboard.

Typically, components of the computing system 600 are connected to the computer using a standards based bus system. In different embodiments, the standards based bus system could be Peripheral Component Interconnect (“PCI”), Microchannel, SCSI, Industrial Standard Architecture (“ISA”) and Extended ISA (“EISA”) architectures, for example.

The computing system 600 also includes various software modules 625. For example, the computing system 600 includes, for example, an operating system such as, for example, Microsoft® XP 630. The computing system 600 may use other operating systems such as: Microsoft® Windows® 3.X, Microsoft® Windows 95, Microsoft® Windows 98, Microsoft® Windows® NT, Microsoft® XP, Microsoft® Vista, Microsoft® Windows® CE, Palm Pilot OS, OS/2, Apple® MacOS®, Disk Operating System (DOS), UNIX, Linux®, VxWorks, or IBM® OS/2®, Sun OS, Solaris OS, IRIX OS operating systems, and so forth.

The computing system 600 can also include software which implements a portion of the virtual underwater environment such as, for example a simulator application 635 compatible with embodiments described herein. In certain embodiments, the simulator application 635 is executed by the CPU and includes, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In certain embodiments, in order for the simulator application 635 to run at a certain specified level of performance, the computing system 600 may preferably include at least a 2 GHz processor, 1 GB of RAM, 100 MB of hard drive space, a 128 MB graphics card compliant with DirectX 9.0, and run Microsoft® XP or Microsoft®Vista. In other embodiments, the simulator application 635 may perform adequately on a computing system 600 having different components or components with different parameters. For example, in certain embodiments, the simulator application 635 may run on a computing system 600 having a processor which runs at less than 2 GHz, less than 1 GB of RAM, less than 100 MB of hard drive space, and/or less than a 128 MB graphics card. The simulator application 635 may run well on a computing system having an Nvidia Geforce 7800GT or ATI Radeon x1800 series or equivalent 256 MB graphics card in certain embodiments.

Although disclosed in reference to a personal computer, ordinarily skilled artisans will recognize from the disclosure provided herein that the computing system 600 may be another type of computing system. For example, in certain embodiments, the computing system 600 comprises a server which may comprise hardware and/or software modules known to be suitable for servers. For example, in certain embodiments the computing system 600 may include HTTP server software (e.g., Apache), database server software (e.g., MySQL), or other server software.

In various embodiments, the computing system 600 comprises a laptop computer, a cell phone, a personal digital assistant, a kiosk, Blackberry® device, game console, or an audio player, for example. In other embodiments, the computing system 600 is another type of portable computing device, a computer workstation, a local area network of individual computers, an interactive wireless communications device, a handheld computer, an embedded computing device, or the like.

### V. Embodiments of a Virtual Underwater Environment Database

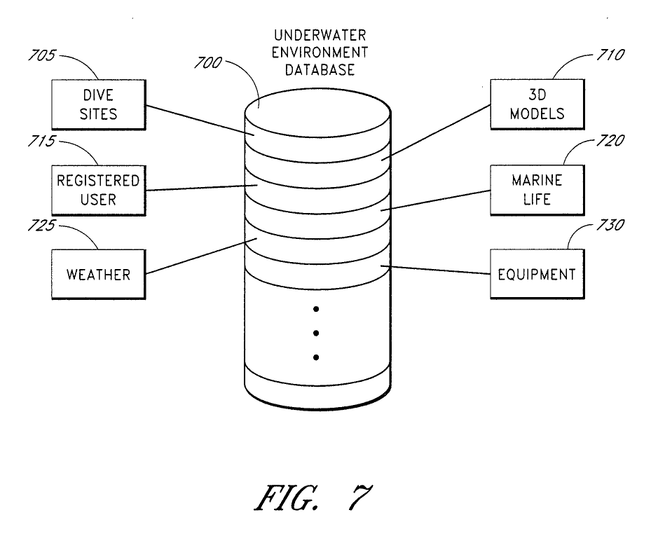

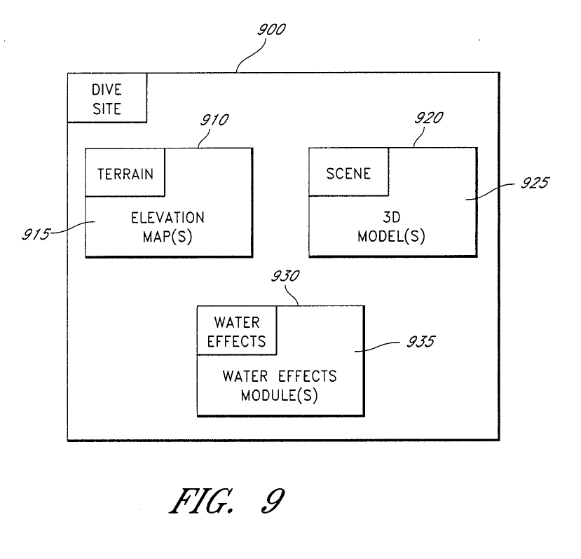

FIG. 7 illustrates a high-level diagram of an example virtual underwater environment database 700 in accordance with certain embodiments described herein. In certain embodiments, the environment database 700 organizes data in a hierarchical fashion. While many different organizational schemes may be utilized in various embodiments to store and access virtual underwater environment data, in certain embodiments, the following database tables are used:

| NAME OF TABLE | DESCRIPTION |
|---|---|
| DIVE_SITES | In certain embodiments, the DIVE_SITES table 705 includes entries |
| | (or records) which hold information about individual dive sites. |
| | Each record can include a unique site id field, for example assigned |
| | to a particular dive site. Each record can also include additional |
| | information relating to the dive site such as, for example, the name |
| | of the dive site, geographical information relating to the dive site |
| | (e.g., country, state, county, city, latitude, longitude, etc.), depth |
| | information (e.g., minimum and maximum depth), difficulty level, |
| | and other information. Those of ordinary skill in the art will |
| | appreciate that each field is of the appropriate type (e.g., string, |
| | integer) and is an appropriate length (e.g., 512 characters, 32 bytes, |
| | etc.). In certain embodiments, each record may include information |
| | relating to the terrain, such as bathymetry (or underwater depth) |
| | and/or topography information relating to the dive site. In certain |
| | embodiments, this information is provided in a separate file or set of |
| | files as described herein, for example, with respect to FIG. 9 below. |
| | For example, in certain embodiments, an XML file includes |
| | references to terrain mapping files which define the terrain for the |
| | dive site and include the bathymetry and/or topography information. |
| 3D_MODELS | In certain embodiments, the 3D_MODELS table 710 can include |
| | records which contain information relating to various 3D models |
| | associated with the virtual underwater environment. For example, |
| | records may be included for various types of marine life, plants, |
| | vehicles, buildings, rocks, and other objects which may be |
| | represented in 3D throughout a dive site. In certain embodiments, |
| | for example, records may include fields relating to a model name, |
| | latest revision date for a model, a description of the model, |
| | classification information relating to 3D models which represent |
| | marine life (e.g., kingdom, phylum, subphylum, class, subclass, |
| | order, suborder, family, subfamily, genus, and species), geographic |
| | information, locations where the 3D models may be located, etc. In |
| | certain embodiments, the DIVE_SITES table 705 can include |
| | information relating to 3D_MODELS associated with a particular |
| | dive site and can cross reference the 3D_MODELS table 715 for |
| | information relating to particular 3D models. In some |
| | embodiments, this information may be provided in a separate file. |
| | For example, and as described herein with respect to FIG. 9 below, |
| | in certain embodiments this information is provided in a file |
| | associated with a dive site. The file, for example, defines all of the |
| | 3D models included in the dive site and provides information |
| | relating to their orientation, placement, and/or movement within the |
| | dive site. |
| REGISTERED_USERS | The REGISTERED_USERS table 715, in certain embodiments, can |
| | contain information relating to users who are registered to use the |
| | virtual underwater environment. For example, the |
| | REGISERED_USERS table 715 can, in certain embodiments, |
| | include a record for each user who is registered to download |
| | information such as dive site information from the server 150. The |
| | REGISTERED_USERS table 715 records can include fields for |
| | biographical information such as the first and last names, age, sex, |
| | and address information for registered users. Fields for information |
| | relevant to diving such as the weight, height, air consumption rate, |
| | number of certified dives complete, etc., may be included in certain |
| | embodiments. In certain embodiments, information related to how |
| | many virtual dives a registered user has completed and how much |
| | money a user has spent on to date in using the virtual underwater |
| | environment may be included in appropriate fields. In certain |
| | embodiments, a dive log id field of a registered user may cross- |
| | reference the appropriate record in a DIVE_LOGS table (described |
| | below) corresponding to the user. In certain embodiments, the |
| | REGISTERED_USERS table 715 may also include fields |
| | corresponding to social information relating to the diver. For |
| | example, information relating to other registered users whom the |
| | registered user may engage in virtual dives with, or share |
| | information relating to the virtual dives with, such as a diver |
| | “buddy-list” may be included. In certain embodiments the database |
| | 700 may include historical information for users such as which dive |
| | sites they have visited and how many times they have visited them, |
| | what types of marine life they have encountered and how much of |
| | the particular marine life they have encountered, how many miles |
| | they have traveled underwater, etc., may be included. In other |
| | embodiments, this information may be included in a separate |
| | database. |
| MARINE_LIFE | In certain embodiments, a MARINE_LIFE table 720 can include |
| | records which hold information relating to the various types of |
| | marine life that can be represented in the virtual underwater |
| | environment. For example, in certain embodiments, the |
| | MARINE_LIFE table 720 includes information relating to a type of |
| | animal. In certain embodiments, for example, there are records for |
| | types of fish (e.g., tuna, tropical fish, sharks, etc.), types of |
| | mammals (e.g., whales, seals, sea otters, etc.), birds (e.g., pelicans, |
| | sea gulls, etc.), and other types of animals. In some embodiments, |
| | there are records for human beings such as other divers and which |
| | are included in the MARINE_LIFE table or in another table. In |
| | certain embodiments, there can be information relating to the |
| | physical characteristics of the animals such as a size or range of |
| | sizes, color or a range of colors, etc. In other embodiments, this |
| | information is stored in another table or file, such as, for example, |
| | the 3D_MODELS table. In certain embodiments, the table 720 can |
| | include behavioral information relating to the particular animals. |
| | For example, in various embodiments, there is information relating |
| | to the schooling patterns of the animals, the general skittishness or |
| | gregariousness of the animals (e.g., their reaction to humans), and/or |
| | territorial behavior. Information relating to the overall number of |
| | the animal that would characteristically be present in a particular |
| | dive site is included in certain embodiments. Information relating to |
| | the behavior or presence of the animals in relation to weather and/or |
| | water conditions such as water temperature, current information, |
| | etc., is provided in certain embodiments. In certain embodiments |
| | there is information relating to size range of the animals and whether |
| | or not a particular instance of an animal is a juvenile or an adult. In |
| | certain embodiments, there is information relating to the various |
| | sounds that the particular animals make. In certain embodiments |
| | there are also records for plant life including, for example, seaweed, |
| | coral, natural reefs, man-made artificial reefs, etc. There can also be |
| | information relating to the amount of the particular plant life that |
| | would typically be present in a particular dive site. In certain |
| | embodiments, there may be a fictional mode or feature in which |
| | there may be records for fictional animals or characters such as, for |
| | example, the Loch Ness Monster or mermaids. |
| WEATHER | In certain embodiments, a WEATHER table 725 is included which |
| | may include records for various weather conditions that may be |
| | present in the virtual diving environment. In certain embodiments, |
| | this information may be included in another location, such as in the |
| | DIVE_SITE table 705. In other embodiments, the DIVE_SITE |
| | table 705 cross-references the WEATHER table to resolve |
| | information relating to potential weather conditions for a dive site |
| | record. In certain embodiments, information relating to currents can |
| | be included in the WEATHER table 725. For example, information |
| | relating to the direction and speed (e.g., in knots) of can be |
| | included. In some embodiments, for example, the WEATHER table |
| | includes records which may include a dive site id. Information |
| | relating to the temperature ranges, frequency and severity of storm |
| | systems, and/or current levels of dive sites, may be included. |
| EQUIPMENT | In certain embodiments, an EQUIPMENT table 730 includes |
| | records holding information relating to equipment associated with |
| | the virtual underwater environment. The EQUIPMENT table 730 |
| | can, for example, include information relating to available diving |
| | equipment. For example, in certain embodiments, information |
| | relating to scuba tanks, wetsuits (e.g., thickness of wetsuit), masks, |
| | swim fins, scuba weights, scuba belts, buoyancy compensators, etc., |
| | is included in the EQUIPMENT table 730. In certain embodiments, |
| | information relating to various types (e.g., different brands) of the |
| | individual gear is included. In certain embodiments, for example, |
| | information relating to whether particular sets of available scuba |
| | equipment are open-circuit (aqualung) type or closed-circuit (re- |
| | breather) type is included. In some embodiments, information |
| | relating to whether certain available scuba sets include demand |
| | regulators, are twin-hose versus single hose, cryogenic, etc. is |
| | included. In certain embodiments, information relating to available |
| | air cylinders is included, such as the size, and material type (e.g., |
| | aluminum, steel, high-pressure steel, etc.), and air capacity (e.g., 80, |
| | 100, 120 cubic feet). In certain embodiments, information relating |
| | to other types of available equipment including snorkel equipment |
| | may be included. In some embodiments, the EQUIPMENT table |
| | 730 cross-references the REGISTERED_USERS table 715 to |
| | include information relating to available equipment associated with |
| | particular users. In certain embodiments, for example, users may |
| | purchase the right to download and use certain types of equipment |
| | in the virtual underwater environment. In some embodiments, |
| | information relating to available vehicle equipment such as boats, |
| | submarines, etc. may be included. In other embodiments, another |
| | separate table may be included to hold such information. |
| DIVE_LOGS | In certain embodiments, a DIVE_LOGS table (not shown) can |
| | include records which contain historical information relating to |
| | virtual underwater environment usage. For example, in certain |
| | embodiments, each record may include information relating to |
| | virtual underwater diving sessions, dive log id including a unique |
| | identifier for the particular dive log record and user id field which |
| | identifies the user associated with the particular dive and may, in |
| | certain embodiments, cross-reference the REGISTERED_USERS |
| | table 715. A site id field is included in some embodiments which |
| | identifies the dive site at which a virtual dive took place and can |
| | cross reference the DIVE_SITES table 705. The DIVE_LOGS |
| | table may also include information relating to a dive such as the start |
| | and end times of the dive, and other dive status information. In |
| | certain embodiments, a link to a “bubble trail” for the particular dive |
| | may be included. A “bubble trail” of certain embodiments |
| | comprises a file or set of data which records the user's virtual |
| | activity in a dive site. In certain embodiments, the “bubble trail” |
| | allows the diver to replicate a dive using the simulator. For |
| | example, a “bubble trail” in certain embodiments is a file or set of |
| | data including time stamped info (e.g., every second) relating to |
| | certain aspects of a dive. For example, attitude (e.g., yaw, pitch, |
| | roll) and position (e.g., easting, northing, altitude) of the diver may |
| | be represented by the bubble trail. In certain embodiments, the |
| | “bubble trail” can be implemented using a diver area system such as |
| | one of the diver area systems disclosed herein. For example, the |
| | diver area system can record user activities and generate a bubble |
| | trail that could be read by the simulator, allowing the virtually |
| | replicate the actual dive. In certain embodiments, the bubble trail |
| | information is stored in the DIVE_LOGS table. In other |
| | embodiments, the bubble trail information is stored in another table |
| | or in another location. In certain embodiments, the DIVE_LOGS |
| | table or another storage structure may include information sufficient |
| | to allow a user to re-simulate a particular diving session or particular |
| | portions or characteristics of the diving session as will be described |
| | in greater detail below. |

In certain embodiments, the database 700 may include all of the tables described above, or only a subset of the tables. In some embodiments, the database 700 can include additional tables as appropriate to store additional information relating to the virtual underwater environment, as will be appreciated by those of skill in the art. In certain embodiments, for example, the environment database 700 may include tables relating to diver associational information such as, for example, on-line buddy information. For example, in some embodiments, the database 700 may include information relating to groups of registered users who engage in virtual dives together over the Internet or another network. Additionally, in certain embodiments the tables, records and/or fields described above may include different information as appropriate to represent the virtual underwater environment. For example, in certain embodiments, more or less information may be included with respect to certain tables, records, and/or fields described above. Those of ordinary skill in the art will appreciate that each field is of the appropriate type (e.g., string, integer) and is an appropriate length (e.g., 512 characters, 32 bytes, etc.).

The information in the database 700 may be organized differently in various embodiments. For example, in certain embodiments, some of the information described as included in the REGISTERED USERS table 715 may be included in other tables such as the DIVE LOGS table. In some embodiments, for example, information described above as included in the MARINE LIFE table 720 and/or the DIVE SITES table 705 may be included in the 3D MODELS field or vice versa.

In certain embodiments, different portions of the database 700 may be physically stored on different computers. For example, in certain embodiments, some of the information or tables may be stored on a client computer or associated database, such as the client computer 200, 500 or database 260, 560 of FIGS. 2 and 5, while other information may be stored on a server system or associated database, such as the server system 250, 550 or database 230, 530 of FIGS. 2 and 5. For example, in certain embodiments, information such as, for example, REGISTERED USER records is stored on a server system while other information such as, for example, the EQUIPMENT record information is stored on the client system. In certain embodiments, the information may be stored in multiple locations. For example, in one embodiment, the user can download information such as a DIVE SITE record and/or 3D MODEL records associated with a particular dive site from a server system to store locally on the client computer (e.g., the user's personal computer).

### VI. Embodiments of a Virtual Underwater Environment Simulator

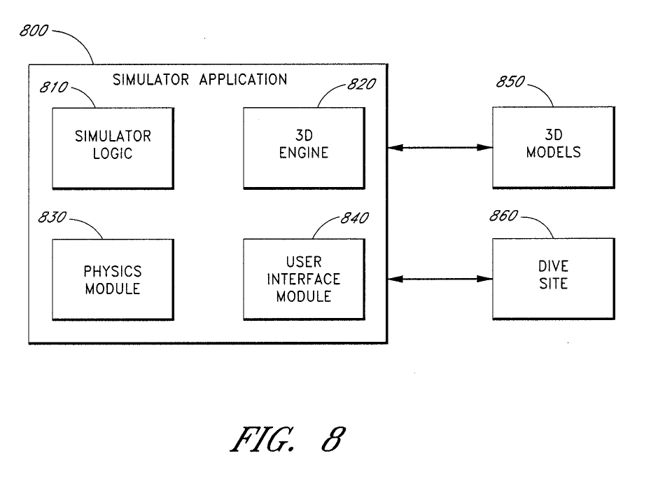

FIG. 8 illustrates a high-level diagram of an example virtual underwater environment simulator application 800 in accordance with certain embodiments described herein. The simulator application 800, in certain embodiments, includes various logical blocks (or modules). For example, simulator application 800 can include a simulator logic module 810, a 3D engine module 820, a diver physics module 830, and a user interface module 840. In certain embodiments, a dive site structure 860, or multiple dive site structures 860, are input into the simulator application 800.

In certain embodiments, the general operation of the simulator application is managed by the logic module 810 (also referred to as a simulator logic engine). For example, in certain embodiments, the simulator logic module 810 generally controls the state of the simulator. The simulator logic may keep track of and control whether a user is in a set up or configuration state (e.g., inputting user information) or whether the user is simulating a dive. In certain embodiments, for example, the simulator logic module 810 determines whether a user wants to exit the simulation or whether a simulation end condition has occurred. In general, many of the simulator functions described herein, including, but not limited to, dive site generation, virtual diver control, feedback and training functions, etc., may be performed by the simulator logic module 810.

In certain embodiments, the 3D engine 820 reads in information relating to the underwater environment and graphically renders the virtual environment. For example, the 3D engine 820 may, in certain embodiments, receive information relating to the dive site (e.g., 3D models, water effects, terrain information relating to the dive site, etc.). One of ordinary skill will appreciate that information relating to the 3D representation of the various 3D objects in the dive site can be input to the 3D engine and rendered to create a 3D image. The embodiments described herein are not limited by any 3D rendering engine and preferably use a 3D engine 820 that can render underwater effects such as underwater light and current effects. In certain embodiments, for example, the 3D engine 820 can include a renderer and one or more of a physics engine, collision detection/response component, sound, scripting, animation, artificial intelligence, networking, streaming, memory management, threading, and/or a scene graph. In certain embodiments, the 3D engine 820 works with computer hardware to provide hardware accelerated graphics. In some embodiments, the 3D engine 820 is built upon an application programming interface (“API”), such as, for example, DirectX 9.0. In certain embodiments, the API provides a software abstraction of a hardware component such a graphics processing unit or a video card. In other embodiments, the 3D engine 820 can be a purely software engine. In certain embodiments, an open source 3D engine can be used (e.g., Open Dynamics Engine, Irrlicht, etc.). In certain embodiments, as will be appreciated by those of skill in the art, the simulator application 800 can include an artificial intelligence module which can receive information related to the behavior of the various living objects represented in the virtual environment (e.g., other divers, fish or schools of fish, etc.).

In certain embodiments, 3D models are generated using modeling and/or rendering software. For example, 3D models in one preferred embodiment may be generated using Autodesk 3Ds MAX 2009. Information relating to the models may be embedded in the model. For example, shading, texturing, skeleton, polygon, and animation information relating to the model may be embedded within the model. In certain embodiments, the models are generated in a standard format but are encrypted before being accessible by a user. For example, the 3D models in one embodiment are encrypted when made available on a server, such as the server system 550 described above.

In one embodiment, the AI module is a separate module that implements a set of behavioral rules associated with each model or set of models and directs the 3D engine according to the set of behavioral rules. For example, in one embodiment, the AI module of the simulator application 800 will receive a set of behavioral rules for each type of 3D model associated with the dive site and will animate each 3D model according to the set of behavioral rules. For example, in one example embodiment, the simulator application 800 may receive a 3D model for a fish which has a characteristic high level of skittishness which is represented in the set of behavioral rules. The AI module will read in the behavioral rule corresponding to the high level of skittishness and direct the 3D engine accordingly. For example, the fish may generally swim away from the virtual diver when they get a certain distance away from the diver. Those of skill in the art will recognize from the disclosure herein that, in various embodiments, the artificial intelligence (“AI”) module can be a separate module, form a part of the 3D engine, or be included in some other part of the simulator application 800. In some embodiments, the behavioral rules may not be stored on the server, but may be stored locally on the computer running the simulator application. In one embodiment, the 3D models are stored locally after the first download from a server.

The diver physics module 830 can, in certain embodiments, perform various functions relating to the physics and/or physiology of the diver during a simulation. For example, the physics module 830 may generally determine how the virtual diver will move throughout the dive site so as to present a realistic simulation of the diver's movements. In certain embodiments, the physics module 830 may determine the acceleration of the diver, the physical response of the diver to collisions with other objects, the effect of currents on a diver's motion, etc. In certain embodiments, the physics module 830 works with the 3D engine 820 to determine and represent the virtual diver's motion throughout the dive site. In other embodiments, the 3D engine 820 includes the physics module 830 or portions thereof. In certain embodiments, the physics module 830 also includes information relating to the physiology of the diver. For example, the physics module 830 may include information relating to the height, weight, sex, etc. of the diver. The physics module 830 may also include information relating to physiological parameters such as blood oxygen content, heart rate, blood pressure, etc. In certain embodiments, for example, the physics module 830 can determine amount of body heat loss the diver has undergone based on various factors such as the water temperature, the user's characteristics (e.g., weight, age, sex) and the user's equipment or activity level. In one embodiment, for example, an older diver who is very active may suffer from a relatively high level of body heat loss. In certain embodiments, this phenomenon can be referred to as the “chill effect”.

In certain embodiments, the physics module 830 also renders the movements of marine life and other objects which move throughout the virtual environment during simulation. The physics module 830 of preferred embodiments is configured to simulate the physics of the diver based on the virtual diver's characteristics and dive site environmental factors. For example, the physics module 830 may virtually represent the buoyancy of the diver based on the equipment, movements, size and weight of the diver. The virtual buoyancy may be affected by environmental factors such as the type of water (e.g., salt water versus fresh water).

In other embodiments, the functions of the physics module 830 are performed by multiple modules. For example, there can be one module that performs the functions relating to the physics of the diver and/or other objects within the dive site, and another module which performs the functions relating to the physiology of the diver.

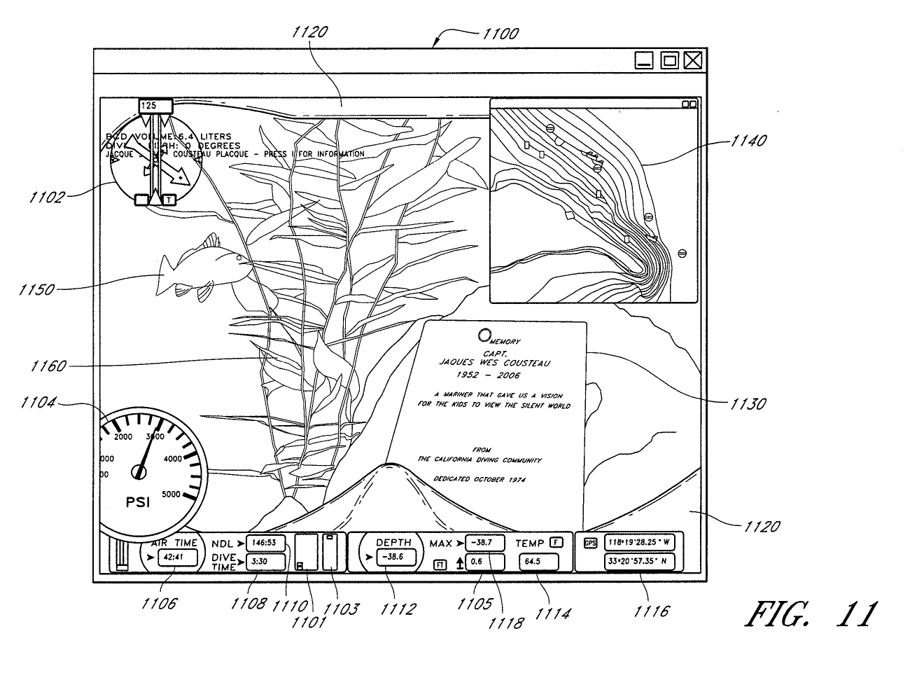

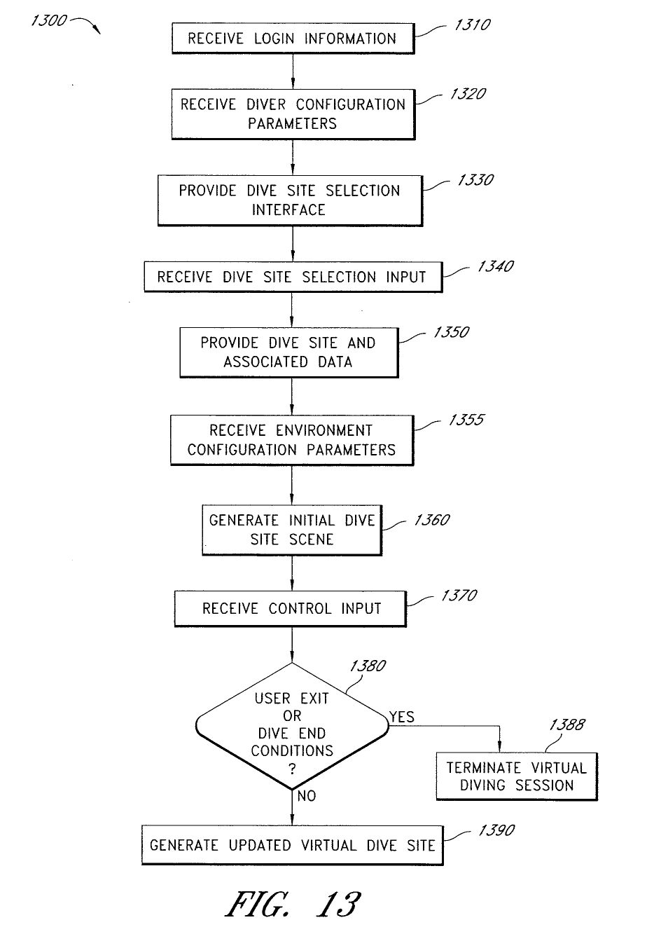

The user interface module 840 allows the user to interact with the simulation. For example, in certain embodiments, the user interface module 840 provides a 3D display to the user representing the virtual diver within the dive site. The user interface module 840 also provides the user a control interface. For example, the user interface module 840 allows the user to set up environment and diver configuration parameters as described herein in greater detail. The user interface module 840 also includes a dive simulation interface which allows the user to control the virtual diver during a virtual dive session. For example, the dive simulation interface allows the user to control the movements of the diver and to configure and monitor certain equipment (e.g., air gauges, map display(s), BCD). Aspects of the user interface module 840 are described in greater detail herein with respect to, for example, FIGS. 11 and 13.

In certain embodiments, the simulator application 800 can simulate conditions which would occur in real life based on the user's control of the simulator application 800. For example, the simulator application 800 can detect when the user would be suffering from decompression sickness, inner ear barotraumas, pulmonary barotraumas, arterial gas embolism, and other conditions that can occur during diving. For example, the simulator application 800 may provide a textual or audio warning that such conditions are about to occur or are occurring, such as when the user is ascending or descending too rapidly. Graphical representation of the conditions, such as a bleared field of vision, black-out, and other realistic representations can also be provided. Conditions relating to equipment may also be simulated. For example, the divers goggles may fog over or pieces of the diver's equipment may become damaged and malfunction, such as when the diver runs into an object in the virtual environment.

In certain embodiments, a virtual dive site structure 860 is kept on a remote server or a database associated with a server (e.g., the server system 150 and/or database 130) and is downloaded into the client computing system on which the simulator application 800 resides (e.g., the client computing system 110) when the user selects the dive site 860. In certain embodiments, 3D models 850 associated with the virtual dive site structure or structures 860 are also input into the simulator application 800. In some embodiments, the dive site structure 860 and/or the 3D models are maintained locally on the computing system (e.g., on hard drive) on which the simulator application 800 resides after the first time they are downloaded. In certain embodiments, the dive site structures 860 and/or the 3D model files 850 are stored as encrypted and/or compressed files and are decrypted and decompressed for each use. In certain embodiments, updates to the site structures 860 and/or 3D models 850 are downloaded to the client computing system when a new version is available on the server computing system. In other embodiments, the dive site structure 860 and/or 3D models 850 are stored on the server computing system and are re-downloaded on each use. In still other embodiments, the 3D models 850 and/or dive site structures 860 are not downloaded from a server but are, for example, included with and installed along with the simulator application 800. In various embodiments, the interaction of the client system, simulator application 800, and the server system described above with respect to the 3D models 850 and the dive site structures 860 may be generally replicated for other information related to the underwater environment (e.g., marine life information, equipment information, user information, etc.).

One or more virtual dive site structures 860 and/or information relating to various 3D models 850, such as 3D models associated with the dive site structure(s) 860 are input into the simulator application 800 in certain embodiments. FIG. 9 illustrates a high-level diagram of an example virtual underwater environment dive site 900 in accordance with certain embodiments described herein. In this example, the dive site 900 is organized as a series of files which define the characteristics of the dive site 900, including a terrain file 910, a scene file 920, and a water-effects file 930.

The terrain file 900 of certain embodiments includes information relating to the terrain in the dive site. For example, the terrain file 900 references one or more elevation maps 915 defining the underwater elevation (or bathymetry) and/or surface elevation (or topography) of the dive site 900. In certain embodiments, the elevation maps 915 are referred to as digital elevation models. The elevation maps 915 includes data corresponding to a three dimensional representation of the locations in the dive site. For example, each terrain coordinate may include X and Y coordinates corresponding to a particular grid cell in the horizontal plane and a Z which represents the elevation corresponding to the grid cell.

In certain embodiments, multiple elevation maps 915 having different resolutions combine to represent the overall terrain of the dive site 900. For example, in one embodiment, there are three elevation maps 915 corresponding to a dive site: 1) a low resolution elevation map 915 representing the entire dive site area at a relatively low resolution; 2) a medium resolution elevation map 915 representing a portion of the dive site area at a second resolution higher than the first resolution; and 3) a high resolution elevation map 915 a relatively small portion of the entire dive site at a resolution higher than the first or second elevation maps 915. In one embodiment, the low resolution map includes one elevation coordinate for each grid cell wherein each grid cell represents a 200 meter by 200 meter area. The low resolution map includes, for example, bathymetric data for the relatively large underwater region surrounding the primary diving area. In one embodiment, the medium resolution map includes grid cells which represent 30 meter by 30 meter regions. For example, the medium resolution map includes topographic data for an island off of which the primary diving area is located. The high resolution map includes, for example, in one embodiment, one elevation coordinate for cell grids which represent 50 cm by 50 cm regions. The high resolution map includes bathymetric data for the primary diving area.

Although described with respect to one embodiment, artisans will recognize from the disclosure herein that the terrain file and corresponding elevation maps 915 may be configured and organized differently. For example, in certain embodiments there are a different number of elevation maps 915, one or more of the elevation maps 915 includes both topographic and bathymetric data, and the resolutions of the different elevation maps 915 can be different from one another.

The scene file 920 of certain embodiments includes information relating to the dive site such as the placement of certain objects within the scene. For example, in certain embodiments the scene file 920 references one or more 3D models 925 which define information relating to the three dimensional representation of one or more objects associated with the dive site 900. For example, as described with respect to FIG. 7 above, 3D models 925 of certain embodiments can correspond to various types of marine life, plants, vehicles, buildings, rocks, and other objects. In certain embodiments, there are 3D models 925 corresponding to any of the various types of marine life, equipment, people, etc. that may be represented in the underwater environment. The scene file 920 of certain embodiments also includes information relating to the orientation, placement, and/or movement of the 3D models 325 within the dive site. For example, in certain embodiments, dive site coordinates of the instance of the object represented by the 3D model within the dive site are defined. For objects which move throughout the dive site during a simulation session, such as, for example, the virtual diver, other divers, marine life, etc., the coordinates are initial coordinates which define the placement and/or orientation of the object at the beginning of the virtual dive.

In certain embodiments, some of the information relating to the number, placement, and/or characteristics of the 3D objects, such as the marine life objects, may be generated in various ways. For example, in one embodiment, the number of 3D objects corresponding to marine and plant life in the environment may be generated dynamically for each dive session. For example, the generation may be random or pseudorandom and may, in certain embodiments, be based on parameters associated with the dive site. In one embodiment, for example, there are parameters defining a range of possible quantities of a particular species present at any given time in a dive site. This information may be stored, for example, in one or more of the tables of the underwater environment database described above, such as for example, the marine life and/or dive site tables. In one embodiment the scene XML file is generated for each dive session based on the dynamic generation. In certain embodiments, a portion of the parameter information may be input by a user.

Additionally, dynamic generation may apply to other aspects of the dive site as well. For example, in one embodiment, weather patterns are randomly generated in a similar manner. Parameters defining particular storm conditions, the frequency with which they may be present in a particular dive site, the severity with which they occur, etc., may be used by the simulator application 800 to dynamically generate weather conditions for a virtual diving session. In one embodiment, a separate XML file is generated to represent the weather conditions.

The water effects file 930 of certain embodiments includes information relating to the visual effects of the water in the environment. For example, the water effects file 930 may reference water effects modules 935 which include information relating to the lighting, texture, shading, wave characteristics, wind speed, and turbidity of the water to be represented in the dive site 900. Information relating to the water effects may be randomly generated as well in certain embodiments For example, in one embodiment, a parameter defines a certain range of turbidity for a particular dive site or portion of a dive site. A value corresponding to a certain level of turbidity may be dynamically selected from the range when the simulator loads the dive site and the water will be rendered to represent the dynamically selected level of turbidity.

In certain embodiments, data relating to the terrain, the 3D models, and/or the water effects files is preprocessed by the simulator application and input to the 3D engine of the simulator application which renders the terrain, the 3D models, and the water effects for display to the user. In certain embodiments, there is no preprocessing required and the data is input directly into the 3D engine for rendering. The 3D engine 820 can be the 3D engine 820 of the simulator application 800 described above or some other 3D engine.

In certain embodiments the terrain file 910, the scene file 920, and the water effects file 930 are extensible markup language (“XML”) files. In certain embodiments, the use of XML files facilitates the sending of dive site 900 data across a network. For example, the use of XML files can facilitate the transmission of dive site 900 data from a server system to a client system. In other embodiments, a different type of markup language or another type of data organization system can be used. Although described with reference to the embodiment of FIG. 9, artisans will recognize from the disclosure provided herein that there could be other organizational schemes for implementing a dive site 900. For example, in certain embodiments, there may be additional files which make up the dive site 900. In various embodiments there may be separate files including files which contain information relating to lighting effects, diver characteristics, etc. In one embodiment, one file includes all of the dive site information. In certain embodiments, the files may be organized differently. For example, in one embodiment, information relating to the terrain and the 3D models may be included in one file instead of two separate files.

In certain embodiments, the simulator application 800 stores information relating to diving sessions. For example, in certain embodiments, the simulator application 800 records information relating to the dive sufficient to allow the user to replay a diving session. The information includes, for example, which dive site the user explored, dive path information indicative of the course the user took during the dive session, control input from the user, etc. The information may include, for example, which dive site the user explored, any diver and environment parameters, and time-correlated commands (e.g., offset from beginning of simulation) entered by the user during a simulated SCUBA dive.

In certain embodiments, for example, the simulator application 800 processes the information relating to the previous dive. For example, in one embodiment, the simulator application 800 provides feedback when the dive is replayed. For example, the simulator application 800, in one embodiment, can pause the replay at a particular point, such as a point where the user made a mistake, and offer advice on how to correct the mistake. In certain embodiments, the advice may be in the form of text which is displayed on the screen, for example. In certain embodiments, the feedback may be visual. For example, if a diver took a wrong turn during his diving session, the simulator application 800 may replay the session up to that point and then cause the virtual diver in the replay to take the correct course. In another embodiment, the simulator application 800 allows for interactive replay of a dive session. For example, the simulator application can allow the user to take over at the point of the mistake and allow the user to remedy the mistake based on the feedback provided.

In certain embodiments, the feedback mode can be turned on and off by the user. In one embodiment, the safety feedback mode is available during normal, non-replay diving sessions as well and the simulator application 800 will determine during the simulation whether the user has made a mistake. In certain embodiments, the simulator application predicts when the user is about to make a mistake and notify the user of the potential mistake before it is made. For example, if the user is ascending too rapidly, is about to enter shark-infested waters, is about to roam too far from their buddy or boat, or is running out of air, the simulator application 800 may attempt to notify the user of the potential danger. In one exemplary embodiment, the simulator application uses diving time and depth to estimate the partial pressure of inert gases that have been dissolved in a diver's tissue and may then display during simulation an indicator that direct ascent is safe or that decompression stops will be required. Such decompression algorithms are well known and may include, for example, the multi-tissue model, the varying permeability model and the reduced gradient bubble model. Those of ordinary skill will appreciate that the present invention is not limited by a particular decompression algorithm. By observing the safe ascent or decompression ascent indicators in the simulator of the present invention, student divers may learn and/or practice how to ascend safely even after relatively deep dives without being exposed to actual physical danger.

In certain embodiments, the simulator application 800 assesses the quality of a diving session based on various metrics and provides associated feedback to the user. For example, in certain embodiments, the simulator application 800 will measure a dive through a dive site against other similar dives throughout that dive site and rank the dives based on the metrics, which may be selected by the user or automatically selected. In one embodiment, for example, a diver may set a dive path throughout a dive site. The user then simulates the dive multiple times and the simulator application 800 will store and process the information related to the multiple diving sessions. The simulator application 800 will rank the dives based on, for example, the time it took the user to complete the dive path and/or how closely the user followed the dive path. In certain embodiments, the recording, playback, and feedback functionalities of the simulator application 800 are implemented by the simulator logic engine 810.

Artisans will appreciate from the disclosure herein that the simulator application 800 can serve as a useful instructive tool for self-study and for use by diving educators. In certain embodiments, for example, a dive instructor may utilize the simulator application 800 to allow a group of diving students to simulate the diving in a dive site before the actual dive. The instructor may monitor the progress of the students and set certain goals that the students will accomplish before they are allowed to perform the actual dive. For example, in one embodiment, the instructor may set the following goals for each of his students: a) each diving student visits certain points of interest in a simulated diving session in a particular order; b) each student complete the dive in a certain period of time; and c) each student completes the dive in a safe manner (e.g., without injuring the virtual diver or causing other safety concerns). The simulator application 800 may, in one embodiment, provide a printout or display for each student providing an indication of their status with respect to the goals set by the instructor.

In certain embodiments, some or all of the previous dive session information may be stored in the underwater environment database 300. In certain embodiments, the information is stored locally on the user's computer while in other embodiments it may be stored on a server such as one of the servers described herein.

Artisans will appreciate from the disclosure herein that, in certain embodiments, the simulator application 800 includes other functions and implements algorithms which perform other tasks associated with providing the virtual underwater environment. Moreover, the organization of the simulator application 800 may vary in alternative embodiments. For example, in certain embodiments, one or more of the simulator logic engine 810, 3D engine 820, physics module 830, and user interface module 840 may not be separate modules and the functionalities of one or more of the modules may be performed by one or more other modules.

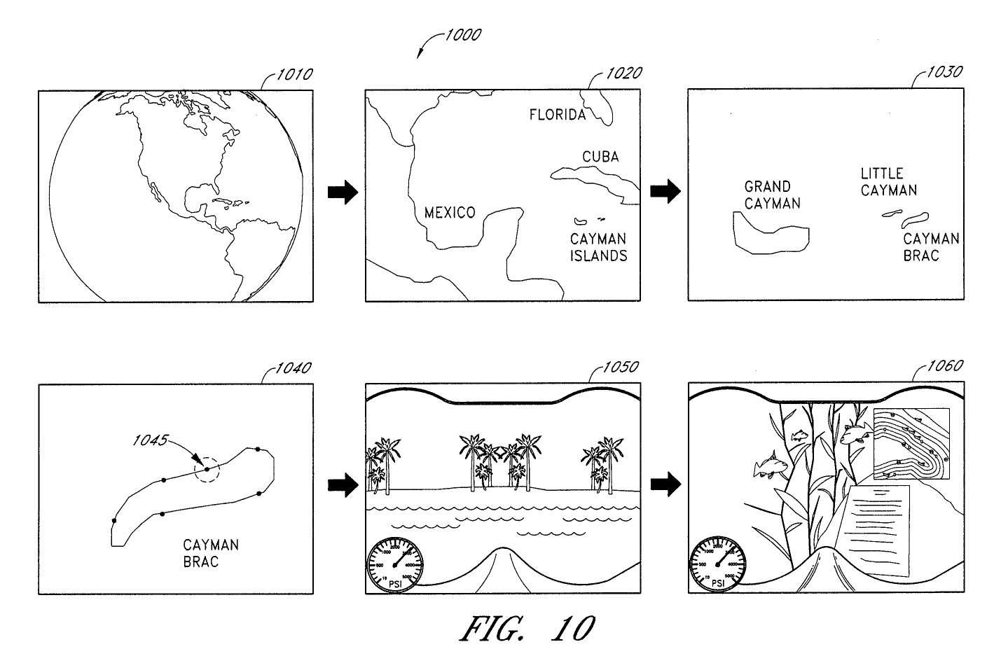

FIG. 10 sequentially illustrate an example virtual underwater environment dive site selection interface 1000 in accordance with certain embodiments described herein. The selection interface 1000 allows a user to select a dive site from the anywhere around the globe in which to have a virtual diving session. The selection interface 1000 is, for example, implemented as part of the virtual underwater environment simulator application, such as the simulator application 800 described above.

In various embodiments, the selection interface 1000 presents an initial view 1010 of the earth. The initial view 1010 represents the earth as a rotatable globe such that the user can, for example, use the mouse to rotate the globe to the desired portion of the earth. Once the user clicks a portion of the earth for their virtual diving session, a surrounding geographical region is selected. The selection interface 1000 allows the user to gradually zoom in on the exact dive site in which to begin the virtual diving session. Sequential views 1010, 1020, 1030, 1040 show an example zoom in process where a user has decided to dive at a dive site near Cayman Brac. The selection interface 1000 allows the user to rotate the globe to North America at view 1010. The selection interface 1000 generally allows the user to zoom down to a regional view 1020, to a view of the Cayman Islands 1030, and to a view of Cayman Brac 1040. In the example embodiment, the user can select a specific dive site 1045 off of Cayman Brac. A pre-diving view 1050 shows the perspective of the virtual diver before submersion. View 1060 shows a diving session simulation view as described herein. In certain embodiments, the selection interface 1000 provides a smooth, visually continuous transition from view 1010 to view 1060 and the views 1010-1060 are shown as discrete images for illustration purposes only. In certain embodiments, the user can zoom back out at any point during the dive site selection process using the selection interface 1000 and use the interface 1000 to navigate to a dive site in a different location.

Although disclosed with reference to the illustrated embodiment, artisans will recognize alternative configurations for the selection interface 1000. For example, in certain embodiments, the globe is presented as a flat map instead of a rotatable spherical globe. In some embodiments, the selection interface 1000 provides discrete views. In various embodiments, the selection interface may provide six general zoom levels 1010-1060. In other embodiments, there may be a different number. In some embodiments, the simulator application includes a textual menu-based selection interface instead of, or in addition to a graphical selection interface 1000. In one embodiment, a user may select a random dive site selection mode where the selection interface automatically (e.g., randomly) selects a dive site for the user.

FIG. 11 illustrates an example screen display of a virtual underwater environment dive simulation interface 1100 in accordance with certain embodiments described herein. The illustrated embodiment shows a virtual diving simulation interface 1100 of a diving session at Casino Point near Catalina Island in Southern California. In the example embodiment, the simulation interface 1100 is implemented on a computer desktop. In certain embodiments, the simulation interface 1100 includes a virtual viewing area which includes a graphical representation, such as a 3D graphical representation, of the current field of view of the virtual diver in the virtual environment.

In certain embodiments, a series of controls are provided so that the user can move the virtual diver throughout the dive site and control the diving equipment. For example, in certain embodiments, there are controls to command the virtual diver to inhale, exhale, move forward, move backwards, change inclination, inflate the buoyancy compensator (BCD), deflate the BCD, and change direction. In certain embodiments, the various controls are executed by keystrokes, combinations of keystrokes, mouse clicks and movement, etc. As will be appreciated by skilled artisans, other appropriate control mechanisms, such as, for example, voice activated control and or user motion activated control may also be used. For example, in certain embodiments the simulator application allows the user to move throughout the dive site at an accelerated speed in order to quickly explore the diving environment. In certain other embodiments the speed may be selectable. A vehicle mode may be implemented in certain embodiments that allows the user to explore the underwater environment in a vehicle, such as, for example, a submarine. In some embodiments, a diver propulsion vehicle (“DPV”) may be included. A user may also be able to simulate non-diving activities such as snorkeling and swimming. Those of skill in the art will appreciate from the disclosure herein that certain aspects of the simulator will differ based on which mode of operation is selected. For example, the simulation interface 1100 may differ. The simulation interface 1100 when simulating submarine operation may include controls and gauges corresponding to those of a submarine rather than those corresponding to dive equipment and controls. When a user is simulating the swimming and snorkeling experience, for example, there may not be any gauges in some embodiments. In addition, other aspects of the simulation may be configured differently based on the type of simulation experience or mode the user is currently utilizing. For example, when in snorkeling or swimming modes, the simulator may be configured so as to limit the amount of time a user can stay underwater without running out of air. A physics module of the simulator application, such as a physics module described above with respect to FIG. 8, may be configured to represent the physics and/or physiology corresponding to the particular mode. For example, the physics module may be configured to represent a slower maximum rate of speed when in swimming mode than when in diving mode.

In certain embodiments, the viewing area 1100 is updated to reflect the current field of view as the user moves the virtual diver throughout the virtual dive site. For example, in certain embodiments, when the user indicates that they would like the virtual diver to swim in a particular direction by inputting a command into the simulation interface, the viewing area is updated as the virtual diver moves. The viewing area can also be updated when the virtual diver moves throughout the environment by other means in certain embodiments, such as when the virtual diver is moved by a current, by contact with an object (e.g., a rock or form of marine life) in the environment, or when the diver inflates or deflates the buoyancy compensator (“BCD”). In certain embodiments, the viewing area is updated by a 3D rendering engine such as one of the 3D engines described herein at a particular frame rate.

The simulation interface 1100 of certain embodiments includes a series of icons representing control instrumentation. For example, the simulation interface includes a compass 1102, a pressure gauge 1104, an air time remaining gauge 1106, a total dive time reading 1108, a no decompression limit (“NDL”) gauge 1110, a depth meter 1112, a maximum depth reached meter 1118, a temperature reading 1114, and positioning information 1116 (e.g., GPS or other positional coordinates). In certain embodiments, the simulation interface 1100 also includes a tissue loading meter 1101 which includes information relating to the oxygen and/or nitrogen levels in the virtual diver's body, a meter 1103 which tracks the ascent/descent rate of the virtual diver, and a meter 1105 which tracks the current elevation of the diver from the sea floor.

In certain embodiments, map 1140 provides the user a bird's eye view of the dive site which can include icons representing the location of the virtual diver within the dive site and the location of other objects such as points of interest, buoys, boats, etc. Marine life, such as fish 1150 and plant life, such as kelp 1120 are shown. The perspective shown can be from the perspective of the virtual diver as represented by the goggle frame 1120.

Points of interest may be located at various locations in the virtual environment on the map 1140 which represent the actual locations in which they reside. Points of interest may include various features of actual diving locations that are represented in the virtual dive site. For example, in the illustrated embodiment, the virtual diver is currently viewing the “Memorial Plaque of Jacques Yves Cousteau” 1130 at the Casino Point, Catalina Island dive site.

In certain embodiments, various annotation items may be associated with certain features associated with the dive site. For example, annotation items may be associated with certain locations, objects, and/or events relating to the dive site. For example, in various embodiments, images, video clips, audio clips, textual annotations, and/or links (e.g., URL links) can be attached to and/or associated with certain locations and objects within the dive site. The annotation items may be attached by a user in certain embodiments. For example, in one embodiment, a user may attach an image of an actual photograph they took during a real dive at a location within the dive site. In one example embodiment, a user may come across a protruding rock in the virtual environment where they saw a green moray eel during a real dive. The user may then attach a video they shot of the eel to the location. In certain embodiments, other users can then interact with the attached annotation item. For example, another user in the example embodiment could view the image of the moray eel when they visit that location in the virtual environment. In certain embodiments, the attached annotation items provide other users with useful information regarding the dive site. For example, in the example embodiment, another user may decide not to actually dive at a particular dive site because they have a fear of moray eels. In some embodiments, annotation items may be associated with events relating to the dive site. The events may be related to conditions affecting the diver, for example. In one embodiment, a user who has lost a certain amount of body heat when actually diving in a certain dive site may leave an annotation item, such as a textual message, including information about the condition (e.g., when it occurred, how it could be avoided, etc.). One of skill in the art will appreciate from the disclosure provided herein that various alternative configurations are possible. For example, in other embodiments, annotation items may be attached by an administrator, uploaded from a server, or come pre-installed with the simulator application. The placement of annotation items within the dive site can advantageously allow users to interact with one another (e.g., to form social networks) and can be used for various purposes such as training, education, and providing advertising content to users.

In certain embodiments, the interface 1100 allows the user to interact with features and locations in the virtual dive site such as, for example, points of interest and/or annotation items attached to locations within the virtual dive site. For example, in one embodiment, information is revealed (e.g., the name of the place of interest) when the user hovers the mouse over the point of interest on the map 1130. In one example embodiment, if the user gets close to a point of interest, a symbol appears on the screen prompting the user to click on it (e.g., an “I” appears indicating there is available information). In certain embodiments, if the user interacts with a symbol certain actions may occur. For example, if the user clicks on the “I” they may be directed to a web site that contains information regarding the specific place of interest. For example, in one embodiment, a user can click on a point of interest and watch a video relating to the point of interest which is being served to a web site when they click on the particular point of interest.

In certain embodiments, the simulation interface 1100 may include an guide mode. For example, an indicator may be presented to the user when in guide mode in order to direct the movements of the diver within the dive site. In one preferred embodiment, the indicator comprises a light which is used to guide the diver to one or more points of interest in the dive site. For example, the light may be positioned on the display so as to direct the user to the point of interest. When the particular point of interest is to the right of the diver but out of the field of view, the indicator may be positioned to the right edge of the display. When the point of interest comes into the field of view the light may be positioned to reflect the position of the point of interest in the field of view. The light may, in certain embodiments, indicate the distance of the user to the point of interest. For example, the light can change in brightness or flash at a certain frequency corresponding to the distance of diver to the point of interest. Those of skill in the art will recognize from the disclosure herein various alternatives to the guide mode. For example, the guide mode can be used to for different purposes. In some embodiments, the dive mode may be used to guide a diver along a pre-selected dive path, or to a certain depth level. The indicator may be different as well. For example, the indicator may comprise an audio (e.g., voice) indicator or an arrow icon which points in the desired direction.

Although the simulation interface 1100 is disclosed with respect to the illustrated embodiment, artisans will recognize from the disclosure herein a variety of alternatives for providing a simulation interface. For example, the view may include additional or alternative perspectives with respect to the virtual diver. In one embodiment, for example, the view is from behind the virtual diver and shows the body of the virtual diver. In certain embodiments the control instrumentation icons include information relating to additional or alternative instrumentation.

### VII. Embodiments of Methods Relating to Virtual Underwater Environment Simulation

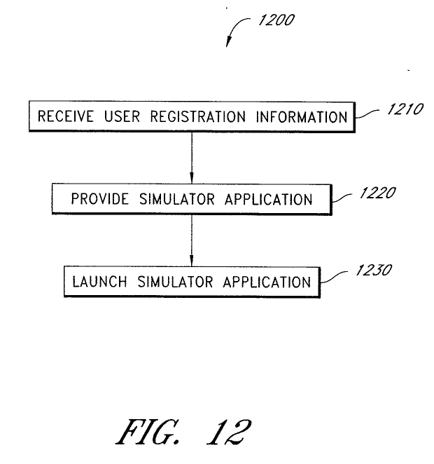

FIG. 12 shows an example method 1200 of configuring a virtual underwater environment simulation application in accordance with certain embodiments described herein. In certain embodiments, the method 1200 receives user registration information at step 1210. For example, the method 1200 receives biographical information (e.g., name, e-mail address, dive experience, etc.). At step 1220, the method 1200 provides the simulator application to the user. For example, the method 1200 allows the user to download and install the simulator application at step 1220. In other embodiments the simulator application may be provided on a storage medium, such as a CD-ROM which may be purchased by the user directly installed on the user's personal computer. At step 1230 the method 1200 launches the simulator application in response to user input.

FIG. 13 shows an example method 1300 of providing a virtual underwater environment simulation session in accordance with certain embodiments described herein. At step 1310 the method receives login information from the user, such as for example, server login information. If the method 1300 determines that the login information is authentic and the user is a registered user, the method 1300 connects the user to the virtual environment server and allows the user to proceed with the simulation session. At step 1320, the method 1300 receives diver configuration parameter input. For example, the method 1300 may receive height, weight, sex and/or surface air capacity information from the user. The method 1300 may also receive information relating to the measurement system the user would like to use during their virtual diving session at step 1320. The method 1300 also receives information relating to the equipment the user would like to use during their virtual diving session at step 1320. For example, information may be received relating to whether or not the user wants the virtual diver to wear a wetsuit, what type of wetsuit (e.g., long, short), what thickness of wetsuit (e.g., 3 mM, 5 mM, 7 mM), what amount of weights will be included with the virtual diving equipment, what capacity scuba tank to use (e.g., 80 cubic feet at standard pressure, 100 cubic feet at high pressure), and what type of tank to use (e.g., aluminum or steel). In certain embodiments there may be additional types of equipment information may be received such as the particular brand of equipment and information relating to the swim fins the virtual diver will wear.

At step 1330 the method 1300 provides a dive site selection interface. In certain embodiments, a dive site selection interface such as the selection interface 600 described herein is provided. At step 1340, the method 1300 receives dive site selection input indicating what dive site the user would like to have their virtual diving session in. At step 1350, the method 1300 provides the dive site and associated data. In certain embodiments, the method 1300 provides the dive site from the virtual environment server and/or database over a network for download. In certain other embodiments the dive site may be installed on the user's computer along with the simulator application and the method 1300 does not provide the dive site over the network for download. In certain embodiments, the dive site and/or associated data is provided over the network for download on initial use and will not be provided for download for subsequent uses unless there is an update to the dive site and/or associated data (e.g. terrain updates, 3D model updates, place of interest updates, etc.).

At step 1355, the method 1300 receives environment configuration parameters. For example, the method 1300 may receive parameters relating to the types and quantities of certain objects or conditions which will be present in the dive site, such as the quantity and types of marine life, the amount and types of plant life, the quantity of other divers, etc. For example, the method 1300 may receive information relating to the size of schools of particular types of fish. Parameters relating to weather conditions may also be received by the method 1300 at step 1355. For example, information relating to air temperature, water temperature, storm conditions, etc., may be received by the method 1300 at step 1355.

In certain embodiments, the parameters received at step 1355 may be provided as ranges of values or as sets of available conditions. For example, the method 1300 may receive information relating to possible ranges of amounts and types of fish that can be present in a dive site during a particular diving session. In some embodiments, a random number generator may be used to randomly select one of the values in a presented range. For example, given parameter ranges of from 23 to 76 garibaldi and 12 to 15 calico bass, a random number selection function may return 31 as an output after being passed 23 and 76 as input parameters, which would then result in 31 garibaldi being generated, and the function may return 20 as an output after being passed 12 and 50 as input parameters, which would result in 20 calico bass being generated.

Additionally, the environment parameters may be selected from or generated from certain realistic scenarios. For example, a range of fish may be selectable or be generated from a set of values which correspond realistic fish life (type, quantity, size, skittishness, etc.) in the actual dive site. Weather parameters may be selectable or generated from a set of weather conditions which actually occur at a particular dive site. For example, hurricane conditions may be available near dive sites in Florida, but not in dive sites near California. Parameters may also be received in certain embodiments which correspond to unrealistic scenarios. For example, in one example embodiment, the method 1300 may receive parameters corresponding to an unrealistic number of a particular type of marine life, or parameters corresponding to unrealistic weather scenarios. For example, the method 1300 may receive parameters which correspond to providing an unrealistic number of great white sharks in one dive site for a particular diving session. Such configurations may be helpful, for example, in training divers to confront adverse scenarios (e.g. shark confrontations or bad weather) or address fears (e.g., of particular types of marine life).

The environment parameters received at step 1355 may be input by a user or automatically generated. In certain embodiments, some of the parameters are input by a user and some are automatically generated. Some or all of the environment configuration parameters may be stored in one or more of the databases described herein, such as the database 700.

At step 1360, the method 1300 generates an initial dive site scene. For example, the method 1300 reads in and processes the dive site information at step 1360 which may include, for example, the dive site structure, the user configuration information received at step 1320, the environment configuration information received at step 1355, etc., and renders the initial dive site scene for display to the user through the simulator interface according to embodiments described herein. In certain embodiments, the initial dive site scene is presented to the user through a simulation interface such as the simulation interface 1100 described herein. The user may then begin the virtual diving session using the simulation interface.

At step 1370, the method 1300 receives control input from the user. For example, the method 1300 may receive information relating to a user's desired change in depth (e.g., inflation of the BCD), change in direction, a desired direction of movement, etc. The method 1300 determines whether or not an exit or dive end condition is present at step 1380. For example, the method may receive input that the user has decided to end the simulation session. In certain embodiments, other end conditions may occur such as, for example, when the method 1300 determines that the virtual diver has incurred a serious injury or has deceased. If the method 1300 determines that an exit or dive end condition is present, the method 1300 terminates the virtual diving session at step 1388.

If the method 1300 determines that there is not an exit or dive end condition present, the method 1300 will generate an updated virtual dive site scene at step 1390. For example, the virtual dive site scene may be updated to reflect movement of the virtual diver, a change in lighting condition of the underwater environment, a change in the position of objects such as marine life within the underwater environment, etc.

### VII. Additional Embodiments

In general, the words “module” as used herein, refers to a collection of software instructions, possibly having entry and exit points, written in a programming language, such as, for example, Java, Lua, C or C++, or to logic embodied in hardware or firmware. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

The networks described herein, such as the networks 140, 1040 may include one or more of any type of electronically connected group of devices including, for instance, the following networks: a virtual private network, a public Internet, a private Internet, a secure Internet, a private network, a public network, a value-added network, a local area network (LAN), a wide area network (WAN), a wired network, a wireless network, an intranet, an extranet, the Internet, a telephone network, a cable television network, voice over IP (VoIP), data, voice and video over IP (DVVoIP), and/or any other type of network or combination of networks. In one embodiment, the network 140 may be capable of providing video, audio, and/or data communications. In addition, the connectivity to the network 140 may be, for example, remote modem, Ethernet (IEEE 802.3), Token Ring (IEEE 802.5), Fiber Distributed Datalink Interface (FDDI) or Asynchronous Transfer Mode (ATM).

It is also recognized that the term “remote” may include data, objects, devices, components, and/or modules not stored locally, that is not accessible via the local bus. Thus, remote data may include a device which is physically stored in the same room and connected to the user's device via a network. In other situations, a remote device may also be located in a separate geographic area, such as, for example, in a different location, country, and so forth.

Although systems and methods are disclosed with reference to preferred embodiments, the disclosure is not intended to be limited thereby. Rather, a skilled artisan will recognize from the disclosure herein a wide number of alternatives for providing a virtual underwater environment. Moreover, the described embodiments have been presented by way of example only, and are not intended to limit the scope of the inventions. Indeed, the novel methods and systems described herein may be embodied in a variety of other forms without departing from the spirit thereof. Accordingly, other combinations, omissions, substitutions and modifications will be apparent to the skilled artisan in view of the disclosure herein.

1. A diver area system for providing a representation of a position of a SCUBA diver, comprising:
a first housing configured to be worn by a SCUBA diver while diving and adapted to house system components;
a processor housed by the first housing;
a storage element housed by the first housing and operably coupled to the processor, the storage element configured to store map data corresponding to a representation of a dive site;
a motion tracking module housed by the first housing and operably coupled to the processor, the motion tracking module generating motion data indicative of the motion of the diver within the dive site, wherein the processor is configured to correlate the motion data with the map data and to generate display data corresponding to a graphical representation of the current position of the SCUBA diver within the dive site; and
a display configured to receive the display data and to generate a visible image representing the current position of the SCUBA diver within the dive site.

2. The system of claim 1, further comprising:
a communication module housed by the first housing and operably coupled to the processor, the communication module configured to send signals representing at least in part a position of the SCUBA diver within the dive site.

3. The system of claim 1, further comprising:
a communication module housed by the first housing and operably coupled to the processor, the communication module configured to receive signals representing at least in part a position of a second SCUBA diver within the dive site.

4-7. (canceled)

8. The system of claim 1, further comprising:
a communication module housed by the first housing and operably coupled to the processor, the communication module configured to receive surface position signals representing a position of one or more surface-based objects, wherein the processor is configured to process the surface position signals to generate second display data representing the current position of the one or more surface-based objects, and wherein the display uses the second display data to generate a visible image representing the current position of the one or more surface-based objects.

9-27. (canceled)

28. A computer implemented method of providing a virtual training environment for SCUBA diving, comprising:
receiving dive site data at least partially corresponding to at least one actual underwater region, the dive site data comprising terrain data comprising information relating to the bathymetry of the at least one underwater region, and the dive site data further comprising scene data comprising information corresponding to one or more objects within the at least one underwater region;
processing the dive site data to generate an interactive graphical simulation including a graphical representation of the at least one actual underwater region;
providing a simulation interface for interacting with the graphical simulation, the simulation interface including at least one movement command; and
responding to the at least one movement command by generating a modified graphical representation of the at least one actual underwater region to simulate movement within the underwater region in a direction corresponding to the movement command.

29. (canceled)

30. The method of claim 28, wherein the simulation interface includes a buoyancy adjustment control, the method further comprising:
responding to at least one signal generated by activating the buoyancy adjustment control by generating a modified graphical representation of the at least one actual underwater region to simulate a change in depth within the underwater region; and
displaying a depth indicator representing a depth within the at least one underwater region.

31. The method of claim 30, further comprising:
receiving SCUBA diver configuration data including a representation of air pressure in an air tank;
displaying an air pressure indicator representing air pressure in the air tank; and
periodically modifying the displayed air pressure indicator to represent a decreased air pressure in the air tank, the rate of decrease in air pressure that is represented by the air pressure indicator varying with changes in depth represented by the depth indicator.

32. The method of claim 31, further comprising:
estimating the partial pressure of inert gases in a SCUBA diver's tissues; and
displaying a decompression indicator representing that direct ascent without one or more decompression stops would be unsafe.

33. The method of claim 32, further comprising:
recording information representing at least a portion of a simulated SCUBA dive in the at least one underwater region; and
responding to a replay command to generate images representing a replay of at least a portion of the simulated SCUBA dive.

34. The method of claim 32, further comprising:
assessing a quality of a simulated SCUBA dive in the at least one underwater region; and
providing feedback representing the assessed quality of the simulated SCUBA dive.

35. (canceled)

36. The method of claim 34, wherein the feedback includes an assessment of the level of safety used in ascending during the simulated SCUBA dive.

37-38. (canceled)

39. The method of claim 28, wherein the terrain data further comprises topography data related to the topography of the at least one underwater region.

40. The method of claim 28, wherein the dive site data further comprises marine life data.

41. The method of claim 28, further comprising:
associating one or more annotation items with a feature of the graphical simulation;
providing the one or more annotation items to a user.

42-47. (canceled)

48. The method of claim 28, further comprising displaying advertising content to a user based on one or more behaviors or characteristics of the user or characteristics of the at least one underwater region.

49. (canceled)

50. A system configured to train divers and familiarize them with actual dive sites, comprising:
input data comprising diver configuration parameters, environment configuration parameters, and dive site data, the dive site data at least partially corresponding to an actual underwater region;
a simulator logic engine configured to accept the input data and to generate an interactive graphically simulated underwater region based on the input data and configured to simulate actual dive conditions;
a 3D engine in communication with the simulator logic engine, the 3D engine rendering a three-dimensional representation of the dive site based on the dive site data;
a user interface module in communication with the simulator logic engine and the 3D engine and comprising a dive simulation interface configured to allow a user to explore the graphically simulated underwater region.

51. The system of claim 50, wherein the actual dive conditions comprise at least one physiological condition.

52. The system of claim 50, wherein the actual dive conditions comprise at least one item of selected SCUBA diving equipment.

53-55. (canceled)

56. The system of claim 50, wherein the dive site data further comprises weather data and the graphically simulated underwater region includes graphically simulated weather conditions.

57. The system of claim 50, wherein the dive site data further comprises water effects data and the graphically simulated underwater region includes graphically simulated water effects.

58-80. (canceled)
